(19) United States
(12) Patent Application Publication
(10) Pub. No.: US 2021/0317297 A1
(43) Pub. Date: Oct. 14, 2021

(54) METHODS AND COMPOSITION OF A DENTAL MODEL FOR THE MANUFACTURE OF ORTHODONTIC APPLIANCES WITHOUT THE USE OF SEPARATOR

(71) Applicant: Structo Pte Ltd, Singapore (SG)

(72) Inventors: Rajeeb Kumar Jena, Singapore (SG); Reno Antony Louis Leon, Singapore (SG); Jeremy Daniel Lease, Singapore (SG)

(21) Appl. No.: 17/258,727

(22) PCT Filed: Jul. 11, 2019
(86) PCT No.: PCT/SG2019/050340

§ 371 Date: Jan. 7, 2021

(30) Foreign Application Priority Data
Jul. 11, 2018 (SG) 10201805969Y

(51) Int. Cl. C08L 33/16; A61C 13/34; A61C 7/08; A61C 7/00; B33Y 70/00; B33Y 80/00

(52) U.S. Cl. CPC C08L 33/16; A61C 13/34; A61C 7/08; B29C 64/135; B33Y 70/00; B33Y 80/00; A61C 2201/00; A61C 7/002

(57) ABSTRACT

Disclosed herein are methods of farming orthodontic appliances without the use of a separating later between the orthodontic appliance and a dental model. Also disclosed herein are dental models having non-adhesive surfaces useful in the formation of orthodontic appliances, as well as curable compositions, kits and cured polymer products useful in the formation of the dental models.

### TECHNICAL FIELD

This invention relates to a curable composition useful in the preparation of dental models by additive manufacturing (e.g. 3D printing) processes. The dental models are useful in the preparation and fabrication of Orthodontic appliances such as Hawley Retainers, Bite plates or the like, using various methods such as ‘Soft & Pepper Technique’, ‘Flasking Technique’, ‘Compressed Investing Technique’ or the like without the use of a separating layer, film or liquid, and where the dental model has high soldering resistance. The invention also relates to the dental models prepared from the curable composition, and methods of preparing the dental models and orthodontic appliances.

### BACKGROUND

Additive manufacturing, also termed as ‘3D Printing’, has completely changed the landscape of mass customization in recent times. The field of applications stretch from automobile, to aeronautics, engineering, healthcare and much more. The adaptation to integrate the platform into workflow has however been more robust in fields like dental and medical industries. The significant advantage 3D Printing offers to these fields is the possibility for complete digitalization of the work flow. This allows the process to be significantly efficient and autonomous as opposed to lengthy manual workflow interventions. Despite CAD/CAM solutions offering the liberty to digitalize the workflow in the dental industry, it had only managed to do so at the industrial level. However, dental 3D printing has made it possible for the end user, in such case a dentist or a dental professional, to explore various chair side models at their practice. This ability to offer customized solutions, in real time has caused a boon for the dental 3D printing market.

The many possibilities offered by 3D printing to digitalize workflows in the dental space has been available in the form of various applications such as printing thermoforming models, precision models, crown and bridge mock-ups, temporaries, castables, denture bases, orthodontic splints, impression trays, surgical guides, gingiva mask or the like. The list expands with new applications emerging each day in the aim for archiving an efficient workflow. Such applications include the 3D printing of Dental Study models and the like using the Structomer Salt & Pepper (S&P) material to be used in the manufacture of Orthodontic appliances (e.g. Hawley Retainers (HR), Bite plates, Dentures, Night Guards etc.) through techniques such as Salt & Pepper Technique, Flasking Technique, Compression Investing Technique and the like.

For example, HRs have been used for teeth alignment over an extended period of time.' The traditional method of making HRs involves cumbersome and laborious multi-step manual process of impression taking, making the stone model using a gypsum paste, trimming, carving, assembly, applying separator, salt & pepper process, post-processing and final polishing before the product is ready for use.' Such multistep processes involve extremely task intensive manual work flow, consume significant amount of waiting time for each step thus making the entire manufacturing process inefficient and may result in random errors during the process. Moreover, the separating medium used in such processes has been shown to influence orthodontic device topography, colour, surface finish and texture leading to undesirable device outcomes. ²

In carrying out a manual dental impression, the impression material is mixed first. The impression material (in powder form) is mixed with water until it achieves a creamy texture (for e.g. alginate which takes approximately 2-5 minutes) (FIG. 1). Silicones or acrylic based mixtures can be used as well. Secondly the impression material is loaded into an impression tray. The impression materials are loaded into impression trays that fit the patient's anatomy, The mandibular and maxillary impressions are then taken. The tray is fitted into the patient's mouth, pressed onto the teeth and after some time, the impression material is set. For alginate, it typically sets after 2.5 minutes when mixed with room temperature water. For final impression removal (step 3), the tray is removed from patient's mouth and rinsed with water. The tray is disinfected, wrapped with wet paper towel and placed into a plastic bag to maintain humidity.

Making stone models manually is a laborious procedure comprising of steps such as mixing the casting material (step 1, FIG. 2). The casting material is mixed with water in required proportions until it achieves a thick creamy consistency. The mixture is then placed on a vibrator to remove all air bubbles. Secondly, casting material is loaded onto the impression tray. Casting material is poured onto the impression trays and this is done on a vibrator to prevent the formation of air bubbles. The casting material is then dried for approximately 45 minutes. In the third step, the model base is added. The model is removed from the impression tray and attached to a base made from the same casting material with less water (for harder texture). Finally, the model is processed. The model is moistened and trimmed using a grinding wheel. Any imperfections are removed from the model using a spoon excavator,

In the manual manufacture of Hawley Retainer (HR) from Stone Models, the dentist prescription design is being referred (Step 1, FIG. 3). In the second step, a sharp tool is used to scrape model for adjustment loops. The model is subsequently marked using pen/pencil along loop line (Step 3) before completing the wire bend along the loop line (Step 4). In step 5, a separator foil is used on the model. If foil is not compatible using a brush evenly spread the separator liquid uniformly on the model (Step 6). The keeper wires are arranged along the loop lines and hot wax or glue is applied to set the wires in place (Steps 7-8). A solder iron, laser or soldering flame is used to fuse the wires where necessary (Step 9). In step 10, the S&P method is used to apply powder, liquid and colour and the stone model is placed into a pressure pot under steam for 80° C, 25 psi, and 5 minutes (Step 11). The acrylic is removed using a knife (Step 12). Finally, in step 13, the final finishes are performed and the retainer is filed to smoothen the edges.

A major disadvantage of using traditional methods in making an orthodontic appliance such as a Hawley Retainer, is that some of the key components used in the process, such as the equipment for impression taking, model making, separator liquid/film, stone model mill etc. are expensive add-ons. In addition, the multistep processes could lead to significant errors which would result in poor outcome of the final product and lack of reproducibility.

Night guards which is another orthodontic appliance, have been used for the prevention of teeth clenching and grinding, treatment of temporomandibular disorder, prevention of teeth wear, tooth pain, crown cracking and the like. The traditional method of making Night Guards by ‘Investing Technique’ involves a tedious multi-step manual process of impression taking, making the stone model using a gypsum paste, trimming, waxing, assembly, wax elimination, mixing, separator application, moulding, packing, curing, compression, post-processing and final polishing before the product is ready for use. Such multistep processes involve extremely task intensive manual work flow, consume significant amount of waiting time for each step thus making the entire manufacturing process inefficient and may result in random errors during the process.

In a manual night-guard investing process (FIGS. 4A-4C), a dental stone model is made from gypsum cast following a similar procedure as detailed earlier in this text. As a first step, the model is set into an articulator and the bite is adjusted to the right degree. Soft wax is then added to the model to form the investing wax shape using alcohol torch and an electric wax knife set at 200° C. The wax is layered and smoothened to the right thickness to ensure bite is closed and then carved to create the edge of the night guard about two-third of the way up the teeth. Canine rise or interior guidance is checked depending on the prescription. Indentations are smoothened out and the assembly is immersed in water to remove air bubbles. The assembly is dried using compressed air and placed in a clean mould frame. The frame is closed and the mould is filled with duplicating material. The entire set-up is allowed to rest for 5 minutes before placing in water for another 5 minutes, The mould is removed from the frame and the model is removed from the mould carefully without damaging it. Necessary holes and cuts in the mould are made and cleaned well before proceeding further. The wax is heated under water, removed from the model and any wax residue is cleaned off from the model followed by steam cleaning and drying, A separator film is applied using a brush on the model surface to prevent any adhesion and allowed to dry. The model is placed back into the mould and the mould back into the frame. Clear splint powder and monomer are mixed into a liquid mixture and the mixture is poured into the mould until the holes are sufficiently filled. The entire assembly is placed in a pressure pot for 25 minutes at approximately 48° C. and 20 psi for the acrylic to cure. The mould is removed from the frame and the model from the mould. The model is chiselled off the night guard and any residual debris is cleared away. Pouring stumps are cut off and any excess material is trimmed on the night guard to the right shape, preventing it from feeling bulky in the mouth. The model is checked for fit and further trimmed where necessary. The final occlusion is checked for sufficient fit before proceeding to polishing using a pumice wheel and a selection of various finishing burrs.

Further examples of orthodontic appliances such as dentures have been used as removable devices that can be used to replace missing teeth. The denture teeth are made out of porcelain or acrylic and held together by an acrylic base. Dentures are primarily used to enable mastication and provide oral aesthetics due to tooth loss sustaining oral cavity balance for the cheeks, lips and tongue, The traditional method of making Dentures by ‘Flasking Technique’ involves a tedious multi-step manual process of impression taking, making the stone model using a gypsum paste, trimming, casting, flasking, separator application, plaster mixing and filling, moulding, packing, curing, flask pressing and compression, post-processing and final polishing before the product is ready for use. Such multistep processes involve extremely task intensive manual work flow, consume significant amount of waiting time for each step thus making the entire manufacturing process inefficient and may result in random errors during the process.³

In carrying out a manual method of flasking a denture (FIGS. 5A-5C), a dental impression is first made following a similar procedure as detailed earlier. The bite registration is then checked for articulation using the upper and lower dental impressions. The porcelain/ceramic teeth are then assembled on the dental impression using a temporary wax base plate. The wax-up is then carved and smoothened to give the base plate a more solid and complete finish. A denture flask is then used to carry out the flasking technique. There are various flasks compatible with microwave, compression press and injection techniques. The denture assemble is set in one of the flask halves using a plaster material. The flask is closed using the other half of the flask and more plaster is subsequently poured to completely cover the set-up. The entire set-up is then placed in boiling water to soften the wax and facilitate separating the flask halves. All residual wax must be carefully removed and thoroughly cleaned after the heat cycle. A separator liquid is evenly applied on all the surfaces of the flask parts using a brush to prevent any adhesion to the denture acrylic to be used in the subsequent steps. The denture acrylic can then be infused into the flask assemble using several methods such a Flask injection or Flask pressing. For the latter, pressure as much as 3000 psi could he used. The flasks are then placed in a water bath for complete acrylic polymerisation. The heating process used to control polymerization is termed the polymerization cycle or curing cycle. One technique involves processing the denture base resin in a constant-temperature water bath at 74° C. (165° F.) for 8 hours or longer, with no terminal boiling treatment. A second technique consists of processing in a 74° C. water bath for 8 hours and then increasing the temperature to 100° C. for 1 hour. A third technique involves processing the resin at 74° C. for approximately 2 hours and increasing the temperature of the water bath to 100° C. and processing for 1 hour. The assembly is then removed and allowed to cool down to room temperature, The flask covers are then removed (deflasking) to separate the plaster encasing the denture. The processed denture is then removed from the mould with the mastercast still intact. The denture is then dislodged from the mastercast for final trimming and finishing. The final finished denture is checked for articulation and fit before use.

There is therefore a need for a dental model which can be prepared by additive manufacturing and on which orthodontic appliances can be prepared without requiring the use of a separating film, liquid or layer, using a variety of techniques such as S&P, Investing and Flasking. This reduces the time required to prepare orthodontic models and increases overall throughput (see FIGS. 1-5). In addition, the digitalization and minimal intervention during the process minimize errors and enables an efficient process. The solution is cost effective and can be entirely performed at a dental practice. The use of separator liquid/film and the resultant long and delayed waiting times under various procedures using cold or heat-based curing, in-flask separation and acrylic separation are avoided. The 3D printable dental model material disclosed herein offers other benefits such as very low water retention and swelling, soldering resistance, non-release of gas bubbles under pressure boiling, high strength, long shelf stability, minimal shrinkage, high contact angle, high thermal property (Tg), light weight and ease of use. The invention relates to a novel structured formulation with precise physical properties to enable an efficient digital manufacturing workflow of orthodontic appliances without the use of separators. The combined benefits of a new material and a novel method renders a highly efficient end-to-end work flow strongly focused on industrial and consumer segments in the dental retainer market.

### SUMMARY OF INVENTION

In a first aspect of the invention there is provided a method of forming an orthodontic appliance comprising:

forming a dental model of a subject's mouth by an additive manufacturing process (e.g. 3D printing); and

forming an orthodontic appliance directly on the dental model without the use of a separating liquid, film or layer.

The orthodontic appliance may be formed on the dental model using a salt & pepper, investing or flasking method.

The additive manufacturing process may use a curable composition or curable mixture as described further herein. The curable composition or mixture may comprise a fluorinated (e.g. perfluorinated) compound and/or a silicone compound. Typically, the fluorinated compound is a fluorinated acrylate and/or the silicone compound is a silicone acrylate.

According to the first aspect of the invention, it is possible to farm an orthodontic appliance on the additively manufactured dental model without the use of a separating liquid, film or layer. Thus, in an embodiment the dental model has non-adhesive properties and the orthodontic appliance does not adhere to the dental model. The dental model may also have non-reactive and/or hydrophobic and/or hydrophilic surface properties, and does not react with the orthodontic appliance or materials used to form the orthodontic appliance. The dental model may also have solder resistant properties.

In a second aspect of the invention there is provided a curable composition for use in forming a dental model, the composition comprising: a monomer and/or an oligomer suitable to form a polymer; a reactive diluent; a polymerisation initiator; a silicone acrylate; and a fluorinated acrylate.

In a third aspect of the invention there is provided a kit of parts comprising a first and second composition, the first composition comprising: a monomer and/or an oligomer suitable to form a polymer; a reactive diluent; a silicone acrylate; and a fluorinated acrylate. The second composition comprises a polymerisation initiator.

In a fourth aspect of the invention there is provided a non-adhesive polymer product obtainable by curing a curable composition according to the second aspect of the invention, or a curable mixture comprising a first composition and a second composition according to the third aspect of the invention.

In a fifth aspect of the invention there is provided a dental model for making an orthodontic appliance wherein:
(a) the dental model comprises a polymer product according to the fourth aspect of the invention, optionally wherein the surface of the dental model has non-reactive, non-adhesive and solder resistant properties; or
(b) the dental model is obtainable by an additive manufacturing process (e.g. 3D printing) using a curable composition according to the second aspect of the invention, or a curable mixture comprising a first composition and a second composition according to the third aspect of the invention.

In a sixth aspect of the invention there is provided a method of forming an orthodontic appliance comprising the use of a curable composition according to the second aspect of the invention, or a curable mixture comprising a first composition and a second composition according to the third aspect of the invention.

In a seventh aspect of the invention there is provided a dental model for making an orthodontic appliance, the dental model comprising a curable composition according to the second aspect of the invention, or a curable mixture comprising a first composition and a second composition according to the third aspect of the invention.

In any aspect of the invention, the curable composition and/or curable mixture may satisfy one or more of the below (I) to (xv):
(i) the monomer and/or an oligomer may be present in an amount of from 20 to 70 wt %; and/or
(ii) the reactive diluent may be present in an amount of from 10 to 30 wt %; and/or
(iii) the initiator may be present in an amount of from 1 to 5 wt %; and/or
(iv) the silicone acrylate may be present in an amount of from 2 to 30 wt %; and/or
(v) the fluorinated acrylate may be present in an amount of from 2 to 10 wt %; and/or
(vi) the fluorinated acrylate may be a perfluorinated acrylate; and/or
(vii) the monomer and/or oligomer may be an acrylate, methacrylate, epoxy, urethane or silicone monomer and/or oligomer, or is a styrene, vinyl alcohol, olefin or glycerol oligomer; and/or (viii) the reactive diluent may be isobornyl acrylate, isobornyl methacrylate, trimethylolpropane triacrylate, triethylene glycol dimethacrylate, 4,4′-oxydianiline, iminocliacetic acid; octadecanedloic acid, dipropylene glycol diacrylate, tripropyleneglycol diacrylate, or the reactive diluent is a multi-functionalized methacrylate, a monoalkenyl aromatic hydrocarbon, an ester of acrylic or methacrylic acid with a C₁₋₁₈ alcohol, an ester of a dicarboxylic acid with a C₁₋₁₈ alcohol, a hydroxyl acrylate or methacrylate, an alkyl hydroxyalkyl ester of maleic acid, an alkyl 2-hydroxyalkyl ester of itaconic acid, an alcohol having an allyl group, an amide or a hydroxy alkylstyrene; and/or
(ix) a surfactant may be present, for example in an amount of from 0,1 to 10 wt %; and/or
(x) an additive may be present, for example in an amount of from 1 to 15 wt %; and/or
(xi) a filler may be present, for example in an amount of from 0.5 to 5 wt %; and/or
(xii) a colourant may be present, for example in an amount of from 0.01 to 2 wt %; and/or
(xiii) the monomer and/or oligomer may comprise: a monomer and/or an oligomer suitable to form a polymeric matrix (e.g. an acrylate and/or methacrylate material); and a monomer and/or oligomer suitable to form a heat resistant component (e.g. a non-acrylate-/methacrylate-containing epoxy methacrylate; a urethane monomer/oligomer; a urethane acrylate; bisphenol-based monomer/oligomer such as bisphenol A epoxy dimethacrylate, bisphenol A epoxy methacrylate, Bifunctional bisphenol A epoxy methacrylate, bisphenol-A diglycidyl ether epoxy, or bisphenol-F diglycidyl ether epoxy; or an epoxy acrylate/methacrylate such as epoxy methacrylate or epoxy novolac acrylate); and/or
(xiv) the viscosity of the composition or the viscosity of a mixture of the first and second compositions of the mixture may be from 500 to 1,300 mPa.s at 23° C., such as from 600 to 1200 mPa.s, such as from 400 to 800 mPa.s at 23° C.; and/or
(xv) following curing of the composition or curing of a mixture of the first and second compositions, the resulting cured material (e.g. a non-adhesive polymer product or a dental model) may have one or more of the following properties (a) to (g):
   (a) a contact angle of from 80 to 150°, such as from 85 to 110° ;
   (b) a tensile strength of from 10 to 80 MPa, such as from 12 to 18 MPa;
   (c) a tensile modulus of from 250 to 2800 MPa, such as from 290 to 350 MPa;
   (d) an elongation to break of from 5 to 40%, such as from 9 to 34% (e.g. from 5 to 20%, such as from 9 to 14% or from 25 to 40%, such as from 37 to 34%);
   (e) a flexural strength of from 10 to 80 MPa, such as from 14 to 17 MPa;
   (f) a flexural modulus of from 800 to 3,000 MPa, such as from 850 to 926 MPa; and
   (g) a shore D hardness of from 50 to 90, such as from 70 to 80.

### BRIEF DESCRIPTION OF DRAWINGS

The drawings are riot necessarily drawn to scale, with emphasis instead generally being placed upon illustrating the principles of the invention. Various embodiments of the invention are described with reference to the following drawings.

FIG. 1 shows the first stage of the process involving dental impression taking.

FIG. 2 shows the second stage of the process involving precision stone model making.

FIG. 3 shows the third stage of the process involving wire placement and salt-pepper protocol for making a Hawley Retainer.

FIGS. 4A-4D show the various stages involving Investing protocols for making Night Guards.

FIGS. 5A-5C. show the various stages in illustrating the process involving Flasking protocols for making Dentures.

FIG. 6 shows a FTIR spectrum for three samples of the curable composition of Example 1.

FIG. 7 shows contact angle measurement for a 3D printed dental model prepared from Example 1 (a), Example 2 (h) & Example 3 (c). Part (d) depicts the contact angle measured while using a separator liquid/film as a control. Part (e) is a representative image of the 3D printed sample used for the contact angle measurements.

FIG. 8 shows a trend for DMA measurement for 3D printed dental model using the composition of Example 2. The Figure indicates Tg onset (Right curve), storage modulus (Left curve), and loss modulus (Middle curve). The inset image shows the 3D printed sample used for the DMA analysis.

FIG. 9 shows 3D scan accuracy measurements for 3D printed dental models used for the manufacture of various orthodontic appliances. The three models shown depict different accuracy tolerance requirements (a) 100 μm (1σ), (b) 100 μm (2σ) and (c) 50 μm (1σ). All three criteria have been successfully met according to the pictograms.

FIG. 10 shows the steps involved in S&P technique using the dental model.

FIGS. 11A and 11B show acrylic retainers made using (a) Dentaurum Orthocryl PMMA Clear Powder and Orthocryl Monomer Liquid (Pink), (b) GLO Superfine Clear Polymer Powder and Clear Monomer Liquid, (c) Lang Ortho Jet Powder (REF 1330) and Ortho Jet Liquid-Pink tint (REF 1304), (d) JBC Crystal Clear Monomer Z and Clear Polymer Powder, (e) JBC Tinted Clear 905 Monomer and Candy Apple Red 25 Polymer (Opaque), (f) JBC Crystal Clear Monomer Z and Red Sparkle aa (Glitter) Polymer, (g) JBC Tinted Grass Green L Monomer and Luminary Pink 2 (Glow) Polymer and (h) JBC Unscented Cherry Tint C Monomer and Candy Apple Red 25 Polymer (Opaque). All retainers were made on an additively manufactured dental model according to the present invention.

FIG. 12 shows illustrative images from the fabrication of Clear Hard Night Guard (Orthodontic Appliance) using Structomer S&P manufactured by the ‘Investing Technique’; (a) 3D printed Flask upper and Flask lower parts using Structomer S&P model material, (b) Clear Hard Night Guard before removal from the Flask Lower after completion of Investing Technique, (c) & (d) Internal and external surfaces of the final finished Clear Hard Night Guard.

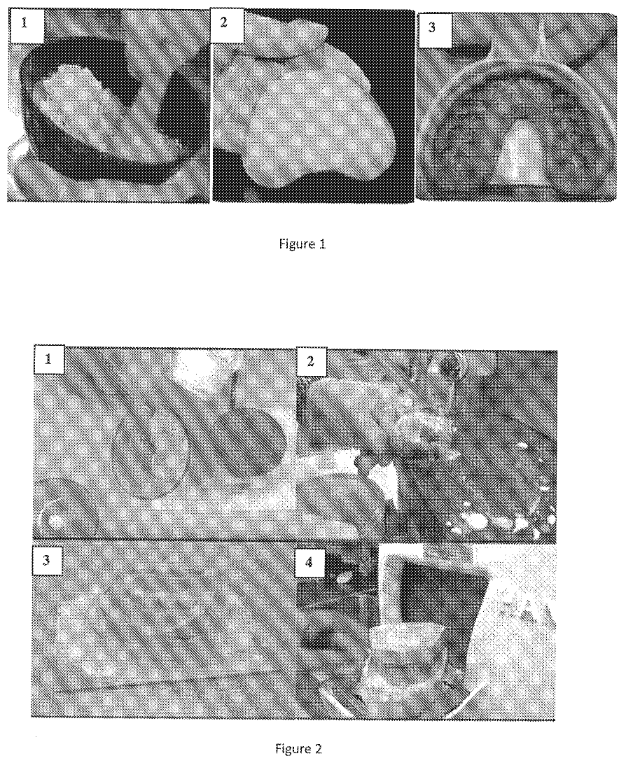

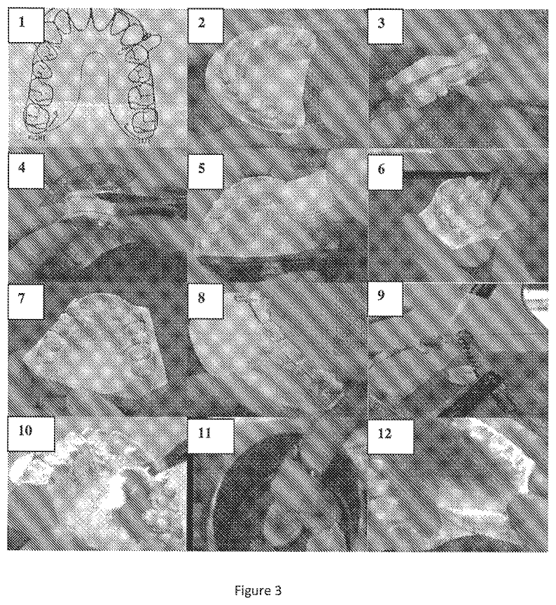

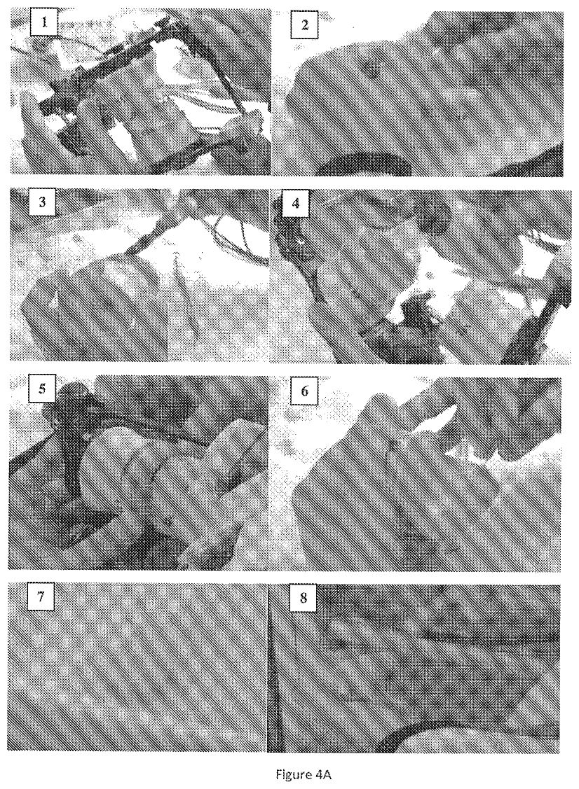

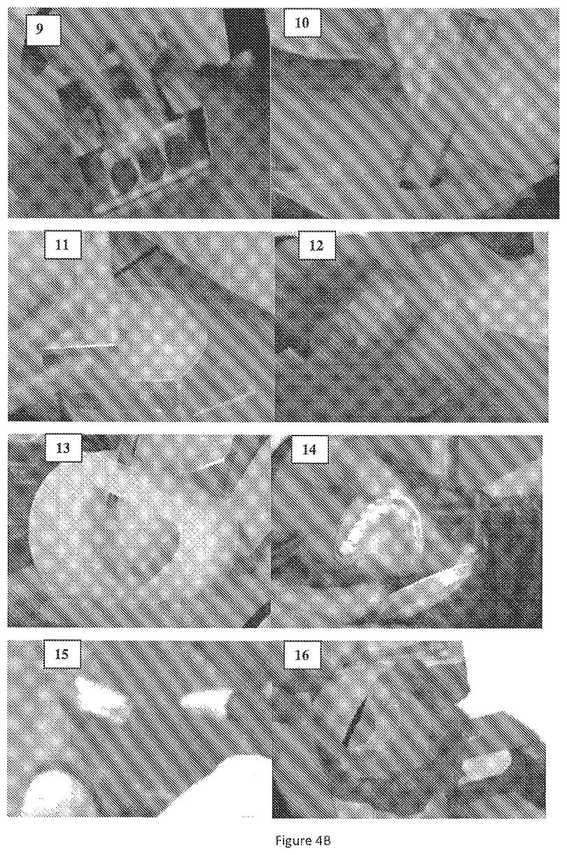

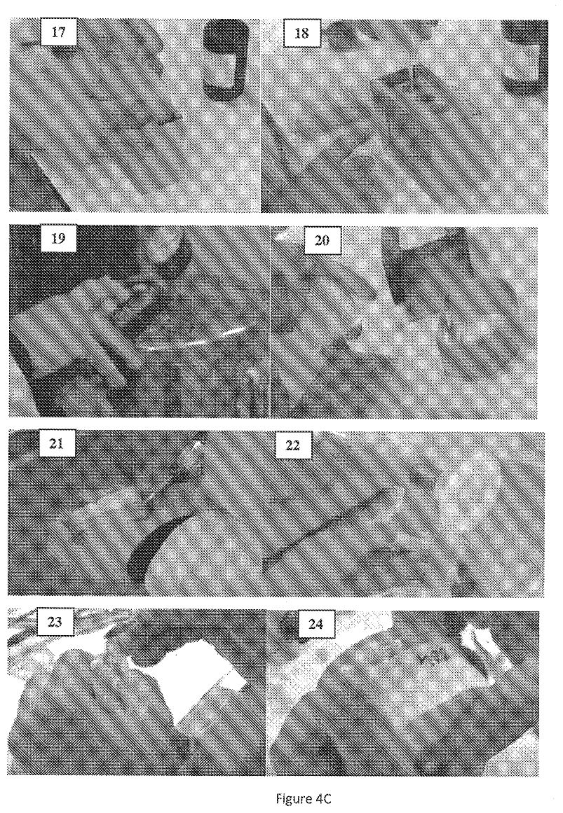

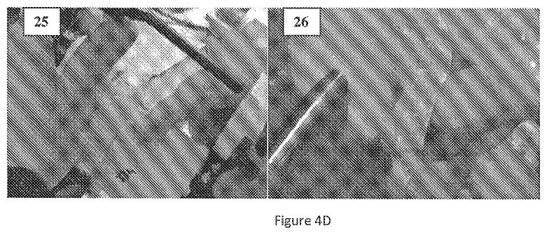

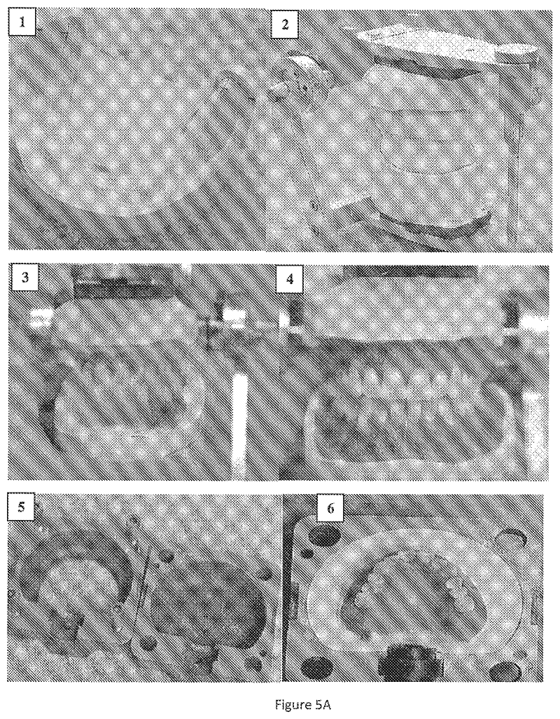

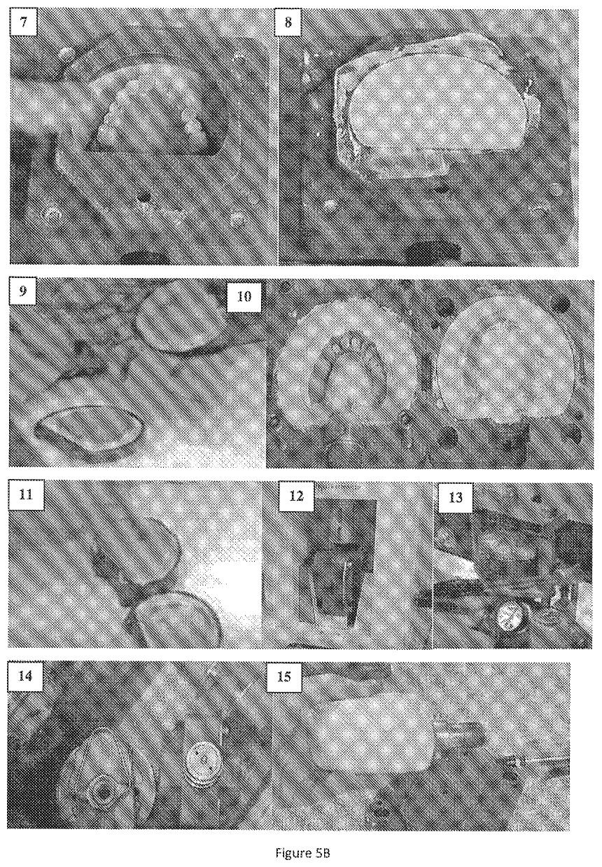

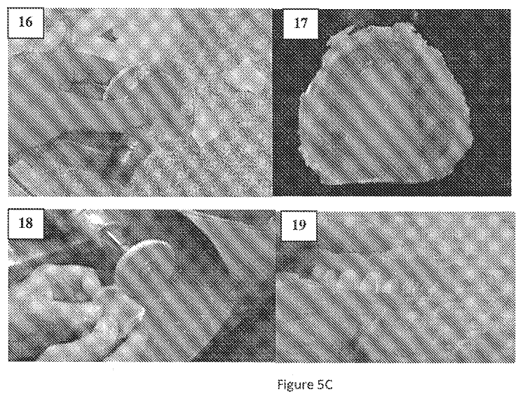

### DETAILED DESCRIPTION OF EMBODIMENTS

Described herein are curable compositions useful in the formation of dental models which are themselves useful in the formation of orthodontic appliances. The curable compositions comprise a combination of multi-phasic components which enable the dental model to have useful properties such as a non-adhesive surface, thermal resistance and robust mechanical strength. The biphasic system involves interfaces for reducing surface activation energy and controlling molecular arrangement. Due to controlled particular arrangement, structure, and morphology, the size of particulates in the formation can be monitored as well if necessary. Substrates of waxes, polymer powders and inorganic fillers have been studied for surface assembly, functionality and structuring. Polymeric materials such as PEGDA, poly (2-carboxyethyl acrylate), PMMA, polystyrene have been shown to influence assembly and structural kinetics by controlling polymer surface properties together with additives. ⁴

The non-equilibrium phase behaviour(s) of multi-phasic mixtures within microscale compartments, their dependence on processing conditions, and their influence on the physical state of materials, chemical interactions during processing on surface functionality and structure formation processes are the many combinations of features expected to serve as driving forces for the non-stick, non-reactive surface property desired. The curable compositions useful in the formation of dental models comprise monomers and/or oligomers, a reactive diluent, a polymerisation initiator, a silicone acrylate, and a fluorinated acrylate. Other components which may be present in the composition include lubricating agents, surfactants, additives, heat stabilizers, flame retardants, fillers and pigments.

The final surface properties of the dental model for orthodontic appliance fabrication depends on the selection of some or all of the listed ingredients and the final operational parameters. As the dental model is required to be non-reactive, non-adhesive and solder resistant, the resin (or curable composition used to obtain the resin) may contain adhesion reduction components which ensure that the orthodontic appliance does not adhere to the dental model during fabrication of the orthodontic appliance. The resin/curable composition may also contain soldering resistant components to ensure that the model surface does not support a flame (i.e. does not burn) under the soldering flame during formation of an orthodontic appliance, such as by S&P technique.

As used herein the term “dental model” means a model of a patient or subject's mouth which is useful in the preparation of orthodontic appliances. In particular, a dental model may assist the preparation or fabrication of an orthodontic appliance which is tailored to the shape of the patient or subject's mouth. Dental models disclosed herein will typically have non-adhesive, non-reactive and solder resistant properties.

As used herein the terms “curable composition” and “curable mixture” mean a composition or mixture comprising monomers and/or oligomers and other components as specified herein, which composition or mixture may he cured to produce a non-adhesive polymer product or a dental model comprising a polymer derived from the monomers and/or oligomers. Typically, the curing is part of an additive manufacturing (e.g. 3D printing) process.

As used herein the terms “separating layer”, “separating film” and “separating liquid” refer to the layer, film or liquid that is placed between a dental model and an orthodontic appliance during the preparation or fabrication of the orthodontic appliance by conventional means. Such separating layers, films and liquids are generally used to prevent adhesion of the dental model to the orthodontic appliance and/or assist removal of the orthodontic appliance from the dental model. As explained herein, the compositions and methods of the present invention allow for an orthodontic appliance to be formed without the use of a separating layer, film or liquid.

Another embodiment of the invention relates to the method for additive manufacturing of the dental model using the curable composition as disclosed herein, where an orthodontic appliance (e.g. a Hawley retainer) can be prepared or fabricated on the dental model, e.g. by using a salt and pepper technique. The additive manufacturing method using the curable composition provides functional dental models having the non-adhesive and solder resistant surface nature necessary to aid in the manufacture of orthodontic appliances (e.g. by S&P technique). Using multiphase, multicomponent curable compositions that enable the lowering of surface tension and enhancing hydrophobicity, the target properties are achieved. Besides, the choice of the ingredients in the curable composition aid in homogeneous mixing and controlled stability which is beneficial in the additive manufacturing process.

### Monomers/Oligomers

Monomers and/or oligomers are the basic building blocks of the curable composition and allow the dental model to have properties such as low shrinkage, high Tg, and excellent balance of mechanical properties. The monomer and/or oligomer content may he in the range of 20% to 70% by weight (wt/wt %) of the total composition (and preferably in the range of 39-56 wt/wt %).

Suitable monomers or oligomers include acrylate, methacrylate, epoxy, urethane, silicone, styrene, vinyl alcohol, olefin or glycerol monomers/oligomers.

Examples of acrylate and methacrylate monomers/oligomers that may be used include, but are not limited to, Dicyclopentenyloxyethyl acrylate, Phenyl methacrylate, 2-Phenylethyl acrylate/methacrylate, Poly(acrylic acid), Poly(benzyi acrylate), Poly(butyl acrylate), Poly(4-chlorophenyl acrylate), Poly(2-cyanoethyl acrylate), Poly(cyanomethyl acrylate), Poly(cyclohexyl acrylate), Poly(ethyl acrylate), Poly(2-ethylhexyl acrylate), Poly(ethyl-α-chloroacrylate), Poly(hexyl acrylate), Poly(isobutyl acrylate), Poly(isopropyl acrylate), Poly(methyl acrylate), Poly(octyl acrylate), Poly(propyl acrylate), Poly(propyl-α-chloroacrylate), Poly(sec-butyl acrylate), Poly(stearyl acrylate), Poly(tert-butyl acrylate), Poly(2,2,3,3-Tetrafluoropropyl acrylate), Poly(methacrylic acici),Poly(benzyl methacrylate), Epoxy methacrylate, Poly(butyl methacrylate), Poly(cyclohexyl methacrylate), Poly(decylmethacrylate), Poly(dodecylmethacrylate), Poly(2-ethoxyethyl methacrylate), Poly(ethyl methacrylate), Poly(hexyl methacrylate), Poly(2-hydroxyethyl methacrylate), Poly(2-hydroxypropyl methacrylate), Poly(isobutyl methacrylate), Poly(isopropyl methacrylate), Poly(methyl methacrylate), Poly(octadecyl methacrylate), Poly(actyl methacrylate), Poly(2-phenylethyl methacrylate), Poly(phenyl methacrylate), Poly(propyl methacrylate), Poly(2-chloroethyl methacrylate), Poly(sec-butyl methacrylate), Poly(4-tert-butylcyclohexyl methacrylate), Poly(tert-butyl methacrylate), Poly(2,2,3,3-tetrafluoropropyl methacrylate), Bisphenol A epoxy dimethacrylate, Aliphatic urethane acrylate, Aliphatic urethane diacrylate, Aliphatic difunctional acrylate, Propoxylated neopentyl glycol diacrylate, Bisphenol A epoxy methacrylate, Difunctional bisphenol A epoxy methacrylate, Acrylic Acid Oligomers, Methyl Methacrylate Oligomers, Methyl Methacrylate Tetramer. Other examples include neopentyl glycol dimethacrylate, epoxy novolac acrylate, and Mono/difunctional phosphorus based acrylated Oligomers.

Examples of epoxy monomers/oligomers that may be used include Bisphenol-A diglycidyl ether epoxy, and Bisphenol-F diglycidyl ether epoxy, Poly(bis-A diglycidyl ether-alt-ethylenediamine, Poly(bis-A diglycidyl ether-alt-hexamethylenediamine), Poly(bis-A diglycidyl ether-alt-octamethylenediamine).

Examples of urethane monomers/oligomers that may be used include Poly[(diethylene glycol)-alt-(1,6-hexamethylene diisocyanate)], Poly[(tetraethylene glycol)-alt-(1,6-hexamethylene diisocyanate)], Poly[(1,4-butanediol)-alt-(4,4′-diphenylmethane diisocyanate)], Poly)[(4(ethylene alt-(4,4′-diphenylmethane diisocyanate)], Poly[(polytetrahydrofuran 1000)-alt-(4,4′-diphenylmethane diisocyanate)].

Examples of silicone monomer/oligomers that may be used include Poly(diethylsiloxane) ;PDES), Poly(dimethylsiloxane) (PDMS), and Poly(methylphenylsiloxane) (PIPS).

Examples of styrene monomers/oligomers that may be used include Styrene-Tetramer-Alpha Cumyl End Group, A-Methyl Styrene-Dimer, A-Methyl Styrene-Tetramer.

Examples of vinyl alcohol monomers/oligomers that may be used include Vinyl Alcohol Trimer, Vinylacetate Trimer, Vinylacetate Oligomer.

An example of an olefin monomer/oligomer that may be used is Poly Isobutylene.

Examples of glycerol monomers/oligomers that may be used include Triglycerol and Polypropylene Glycol Family oligomers such as Poly Propylene Glycol (Dihydroxy Terminated).

Particular examples of monomers/oligomers that may be used include Bisphenol A epoxy dimethacrylate, Propoxylated neopentyl glycol diacrylate, Aliphatic urethane diacrylate, and Difunctional bisphenol A epoxy methacrylate and combinations thereof.

It has been observed that methacrylates exhibit lower shrinkage and better mechanical property compared to acrylate-based compositions. A particular monomer/oligomer which may be used is Bis-GMA (bisphenol A-glycidyl methacrylate), which has superior properties such as high molecular weight and stiffness, partially aromatic molecular structure, low polymerization shrinkage, rapid hardening, low volatility, high refractive index, good adhesion property, and excellent mechanical properties, Another particular monomer/oligomer is bisphenol A dimethacrylate.

As noted hereinbefore, the cured composition will benefit from heat resistant properties These can be obtained by including a heat resistant component into the monomer/oligomer used to form the polymeric matrix, and/or by including monomers/oligomers that are not compatible with the acrylate/methacrylate polymerisation but which form separate polymeric chains having a heat resistant effect.

Suitable monomers/oligomers used in the present invention may comprise a compound suitable for forming a heat resistant component and a compound suitable for forming a polymeric matrix, and/or a compound which is suitable for forming both a heat resistant component and a polymeric matrix.

The heat resistant component may be non-acrylate-/methacrylate-containing epoxy monomers/oligomers; urethane monomers/oligomers; urethane acrylates; bisphenol-based monomers/oligomers, such as bisphenol A epoxy dimethacrylate, bisphenol A epoxy methacrylate, difunctional bisphenol A epoxy methacrylate, bispheriol-A diglycidyl ether epoxy, or bisphenol-F diglycidyl ether epoxy; or an epoxy acrylate/methacrylate such as epoxy methacrylate. Another example of an epoxy acrylate is epoxy novolac acrylate.

For the avoidance of doubt, the heat resistant component may be presented as part of a monomer/oligomer that is compatible with the acrylate/methacrylate used to form the polymeric matrix. As such, the heat resistant component may be completely integrated into the acrylate/methacrylate polymeric matrix. In other words, all of the monomer/oligomer used to form the polymeric matrix may be a compound that has a heat resistant component. In certain embodiments, more than 50 wt % (e.g. 60 wt %, 70 wt % or 100 wt %) of the monomers/oligomers may be an acrylate/methacrylate that incorporates a heat resistant component. In other embodiments, less than or equal to 50 wt % of the (e.g. 40 wt %, 20 wt % or 10 wt %) of the monomers/oligomers may be an acrylate/methacrylate that incorporates a heat resistant component. The compound suitable for forming a heat resistant component, and compound suitable for forming a polymeric matrix may be the same compound.

Examples of monomers/oligomers suitable for forming a heat resistant component include, but are not limited to, urethane acrylates; a bisphenol moiety such as bisphenol A epoxy dimethacrylate, bisphenol A epoxy methacrylate, difunctional bisphenol A epoxy methacrylate, bisphenol-A diglycidyl ether epoxy, or bisphenol-F diglycidyl ether epoxy; or an epoxy acrylate/methacrylate such as epoxy methacrylate. Another possible monomer/oligomer suitable for forming a heat resistant component is epoxy novolac acrylate.

As will be appreciated, the polymeric matrix material will also incorporate other monomers/oligomers that are compatible with acrylate/methacrylate groups. These include fluorinated acrylate and silicone acrylate, as well as vinyl monomers/oligomers.

As noted above, the heat resistant component may be formed from non-acrylate epoxy and urethane monomers/oligomers. It will be appreciated that these materials are not compatible with the polymerisation chemistry/processes used to polymerise the acrylate/methacrylate and compatible groups (e.g. UV curing) and so will be subjected to alternative polymerisation techniques. This also applies to any other acrylate/methacrylate non-compatible monomers/oligomers that are used herein. If the acrylates/methacrylates and any non-compatible monomers/oligomers both include materials capable of forming crosslinks within the respective polymeric chains, then a semi- or fully-interpenetrating polymer network may be formed. It will be appreciated that the non-compatible monomers/oligomers may be subjected to polymerisation before the methacrylates/acrylates and so may be added to the polymeric mixture in the form of polymers/oligomers.

It will be appreciated in the above section that reference to a “poly” material relates to the monomer used to make the resulting polymer and/or may also refer to the oligomeric material. It will also be appreciated that certain monomers and/or oligomers could fall into a number of the above classes, for example a monomer/oligomer could be both an acrylate and urethane monomer or oligomer. For the avoidance of doubt, the monomers/oligomers mentioned herein may be used alone or in any technically sensible combination.

Reactive Diluents

Reactive diluents reduce the viscosity of the composition. The content of reactive diluents in the compositions may be in the range of 10% to 30% by weight (wt/wt %) of the total composition (and preferably in the range of 13-26 wt/wt %). The use of reactive diluents enables the viscosity of the curable composition to be sufficiently optimized to be used in the additive manufacturing (e.g. 3D printing) platform to aid in high polymerization conversion, This provides beneficial mechanical properties of the dental model.

Examples of reactive diluents include compounds having at least one ethylenically unsaturated group (e.g. vinyl groups, allyl groups, or methacrylate groups), and compounds having at least one hydroxyl functional group. It will be appreciated from the present disclosure that reactive diluents may have other functional groups.

Examples of reactive diluents having one ethylenic double bond include monoalkenylaromatic hydrocarbons such as styrene, p-chlorostyrene, and alpha-methylstyrene; an ester of (meth)acrylic acid with an alcohol having 1 to 18 carbon atoms (e.g., methyl (meth) acrylate, and butyl (meth)acrylate), and an ester of a dicar boxylic acid such maleic acid, fumaric acid, and itaconic acid with an alcohol having 1 to 18 carbon atoms (e.g., dimethyl maleate).

Examples of additional reactive diluents with hydroxyl functional groups also include, but are not limited to, hydroxy (meth)acrylates such as 2-hydroxyethyl (meth)acry late, 2-hydroxypropyl (meth)acrylate, and 2-hydroxybutyl (meth)acrylate, an alkyl (hydroxyalkyl) ester of maleic acid such as methyl(2-hydroxyethyl) maleate, ethyl(2-hydroxy ethyl) maleate, propyl(2-hydroxyethyl) maleate, butyl (2-hydroxyethyl) maleate, methyl(2-hydroxypropyl) maleate, and ethyl(2-hydroxybutyl) maleate, an alkyl (2-hydroxyalkyl) ester of itaconic acid such as methyl(2-hydroxyethyl)itaconate, ethyl(2-hydroxyethyl)itaconate, propyl(2-hydroxyethyl) itaconate, ethyl(2-hydroxypropyl) itaconate, and methyl(2-hydroxybutyl) itaconate, an alcohol having an allyl group such as allyl alcohol, an amide such as hydroxymethylacry lamide and hydraxymethylmethacrylamide, and a hydroxy alkylstyrene such as hydroxymethylstyrene and hydroxyethylstyrene.

Specific examples of reactive diluents include multi-functional compounds such as !BOA (isobornyl acrylate), IBOMA (isobornyl methacrylate), TMPTA (trimethylolpropane triacrylate), TEGDMA (triethylene glycol dimethacrylate), ODA (4,4″-oxydianiline), IDA (iminodiacetic acid), ODDA (octadecanedioic acid), DPGDA (dipropylene glycol diacrylate), and TPGDA (tripropyleneglycol diacrylate). These reactive diluents may be used separately or in combination in order to reduce the viscosity. Optionally, multi-functionalized methacrylate diluent with low viscosity may be added into the solution mixture as well.

Some other examples of reactive diluents are N,N-methylene bisacryiamide, N,N′-methylenebismethacry lamide, 1.2-, 1.3-, and 1,4-butanediol di(meth)acrylate, ethyleneglycol di(meth)acrylate, propylene glycol di(meth) acrylate, diethyleneglycol di(meth)acrylate, triethyleneglycol di(meth)acrylate, polyethyleneoxide glycol di (meth)acrylate, dipropyleneglycol di(meth)acrylate, triethyleneglycol di(meth)acrylate, glycerol di(meth)acrylate, glycerol tri(meth)acrylate, 1.2- and 1,3-propanediol di(meth) acrylate, 1.2-, 1.3-, 1.4-, 1.5- and 1.6-hexanediol di(meth) acrylate, 1.2- and L3-cyclohexanediol di(meth)acrylate, pen taerythritol di(meth)acrylate, pentaerythritol tri(meth) acrylate, pentaerythritol tetra(meth)acrylate, trimethylolpropane tri(meth)acrylate, ethoxylated trimethy lolpropane tri(meth)acrylate, tris (2-hydroxyethyl) isocyanu rate tri(meth)acrylate, triallyl isocyanurate, allyl(meth)acry late, pentaerythritol diallyl ether, pentaerythritol triallyl ether, pentaerythritol tetraallyl ether, diallyl ether, tetrally loxyethane, tetrallyloxypropane, tetrallyloxybutane, divinyl benzene, divinyltoluene, diallyl phthalate, divinyl xylene, trivinyl benzene, trivinyl morpholine (acryloylmorpholine), isobornyl acrylate (isobornyl acrylate), isobornyl methacrylate (isobornyl methacrylate), tetrahydro-Pugh furyl acrylate (tetrahydrofurfuryl acrylate), 2-phenoxyethyl acrylate (2-phenoxyethyl acrylate), stearyl acrylate (stearyl acrylate), caprolactone acrylate (caprolactone acrylate), tripropylene glycol diacrylate (tripropyleneglycol diacrylate), 1,6-hexanediol diacrylate (1,6-hexanediol diacrylate), trimethylolpropane triacrylate (trimethylolpropane triacrylate), ethoxylated trimethylolpropane triacrylate (ethoxylated trimethylolpropane triacrylate), pentaerythritol triacrylate to penta acrylate (pentaerythritol triacrylate), and di-penta erythritol. The reactive diluent may be hexadecyl acrylate (dipentaerythritol hexaacrylate) and/or divinyl ether.

A particular reactive diluent that may be mentioned in embodiments herein is isobornyl methacrylate (IBOMA), which may be provided in liquid form.

For the avoidance of doubt, the reactive diluents mentioned herein may be used alone or in any technically sensible combination.

### Polymerisation Initiators

Suitable polymerisation initiations useful in the invention include both photo and thermal initiators. Photo and thermal initiators may be used separately or in combination to initiate crosslinking of unsaturated hydrocarbons. The photoinitiators used may be cationic, anionic or free radical photoinitiators.

The content of polymerisation initiators in the compositions may be in the range of 1% to 5% by weight (wt/wt %) of the total composition (and preferably in the range of 1-2.5 wt/wt %).

Representative examples of photoinitiators include, but are not limited to, Diphenyl (2,4,6-trimethyl benzoyl)phenyl phosphine oxide, phenylbis (2,4,6-trimethyl benzoyl)phenyl phosphine oxide, 2,4,6-trimethylbenzoyl diphenyl phosphine, 2-hydroxy-2.-methyl-1-phenyl-1-propane, benzophenone, hydraxycyclohexylphenyl ketones, alpha-amino ketone, 4-(2-hydroxyethoxy)phenyl-(2-hydroxy-2-propyl)ketone: 2-hydroxy-2-methyl-1-phenyl-propan-1-one: 2-isopropyl-9H-thioxanthen-9-one; benzoin alkyl ethers, benzophenones such as 2.4.6-trimethylbenzophenone and 4-methylbenzophenone, trimethylbenzoylphenylphosphine such as 2.4.6-trimethylbenzoyl-diphenyl-phosphine oxide or phenylbis(2,4,6-trimethylbenzoyl)phosphine oxide, azo compounds such as AIBN, anthraquinones, and substituted anthraquinones such as alkyl-substituted or halo-substituted anthraquinones, other substituted or unsubstituted poly nuclear quinines, acetophenones, thioxanthenes, ketals, and acylphosphines and the like, which are suitable for the UV and visible ranges.

The initiator can also be a thermal initiator which is activated by heat. Examples of thermally activated initiators include peroxides such as dicumyl peroxide, t-butyl perbenzoate, t-butyl hydroperoxide, succinic acid peroxide, cumene hydroperoxide, acyl peroxide, ketone peroxide, dialkyl per oxide, hydroperoxide, methyl ethylketone peroxide, benzoyl peroxide, and the like, as well as azo compounds such as azobis-buty ronitrile.

Particular initiators that may be mentioned herein are the photoinitiators Diphenyl (2,4,6-trimethyl benzoyl)phenyl phosphine oxide and phenylbis (2,4,6-trimethyl benzoyl)phenyl phosphine oxide, which may be used alone or in combination.

For the avoidance of doubt, the polymerisation inhibitors mentioned herein may be used alone or in any technically sensible combination.

### Silicone Acrylates

Silicone acrylates exhibit excellent anti-stick properties due to their low-surface energy, ultra-low Tg, strong slip, release and flow properties. They can be used to modify the surface properties of the dental model. The content of silicone acrylate in the compositions may be in the range of 2% to 30% by weight (wt/wt %) of the total composition (and preferably in the range of 14-24 wt/wt %).

One of the many examples of silicone acrylates, silicon urethane acrylate combines the characteristics of silicones and urethanes, possessing acrylate functionality for UV/EB curing. A wide variety of silicon urethane acrylate materials are commercially available in the market.

In some embodiments, suitable silicone acrylates that may be used include, but are riot limited to, phenyltetraethyldisiloxanylether methacrylate, aliphatic siliconized urethane acrylate, triphenyldimethyldisiloxanylmethyl acrylate, silicone polyester acrylate, isobutylhexamethyltrisiloxanylmethyl methacrylate, methyldi(trimethylsiloxy)-methacryloxymethylsilane, n-propyloctamethyltetrasiloxanylpropylmethacrylate, pentamethyldi(trimethylsiloxy)-acryloxymethylsilane, t-butyltetramethyldisiloxanylethylacrylate, n-pentylhexamethyltrisiloxanylmethylmethacrylate, silicone polyester acrylate, tri-i-propyltetramethyltrisiloxanylethyl acrylate, pentamethyldisiloxanylmethyl methacrylate, heptamethyltrisiloxanylethyl acrylate, polyether modified polydimethylsiloxane, tris(trimethylsiloxy-3-methacryloxypropylsilane and phenyltetramethyldisiloxanylethyl acrylate, and mixtures thereof.

Particular silicone acrylates that may be mentioned herein include aliphatic siliconized urethane acrylate, and silicone polyester acrylate.

For the avoidance of doubt, the silicone acrylates mentioned herein may be used alone or in any technically sensible combination.

Fluorinated Acrylates

The requirement for non-adhesiveness of the surface and its functionality can also be controlled by incorporating fluorinated monomers (e.g. fluorinated acrylate) into the formulation. This not only enhances the hydrophobicity and anti-stick properties but also takes part in the polymerization due to the UV curable acrylate functionality. The exceptional surface functionality of fluorinated monomer is mainly due to their low polarizability, strong electronegativity, and low van der Wink radius (1.32 Å) of the fluorine atom and strong C—F bond (whose bond energy dissociation is 485 kJ mol⁻¹). The content of fluorinated acrylate in the compositions may be in the range of 2% to 10% by weight (wt/wt of the total composition and preferably in the range of 3.5-8 wt/wt %.

A fluorinated group or fluorinated acrylate as used herein is preferably a perfluorinated group or perfluorinated acrylate.

Suitable fluorinated acrylates may include, but are not limited to, fluoroalkyl (meth) acrylate, trifluoroethyl(meth)acrylate, 2,2,3,3-tetrafluoro-n-propyl (meth)acrylate, 2,2,3,3-tetrafluoro-t-pentyl (meth)acrylate, 1H, 1H, 3H-hexafluorobutyl acrylate, 2,2,3,4,4,4-hexafluorobutyl (meth)acrylate, 2,2,3,4,4,4-hexafluoro-t-hexyl (meth)acrylate, 2,3,4,5,5,5-hexafluoro-2,4-bis(trifluoromethyl)pentyl (meth)acrylate, 2,2,3,3,4,4-hexafluorobutyl (meth)acrylate, 2,2,2,2′,2′,2′-hexafluoroisopropyl (meth)acrylate, 2,2,3,3,4,4,4-heptafluorobutyl (meth)acrylate, 2,2,3,3,4,4,5,5-octafluoropentyl (meth)acrylate, 2,2,3,3,4,4,5,5,5-nonafluoropentyl (meth)acrylate, 2,2,3,3,4,4,5,5,6,6,7,7-dodecafluoroheptyl (meth)acrylate, 3,3,4,4,5,5,6,6,7,7,8,8-dodecafluorooctyl (meth)acrylate, 3,3,4,4,5,5,6,6,7,7,8,8,8-tridecafluorooctyl (meth)acrylate, 2,2,3,3,4,4,5,5,6,6,7,7,7-tridecafluoroheptyl (meth)acrylate, 3,3,4,4,5,5,6,6,7,7,8,8,9,9,10,10-hexadecafluorodecyl (meth)acrylate, 3,3,4,4,5,5,6,6,7,7,8,8,9,9,10,10,10-heptadecafluorodecyl (meth)acrylate, 3,3,4,4,5,5,6,6,7,7,8,8,9,9,10,10,11,11-octadecafluoroundecyl (meth)acrylate, 3,3,4,4,5,5,6,6,7,7,8,8,9,9,10,10,11,11,11-nonadecafluoro-unclecyl (meth)acrylate, 3,3,4,4,5,5,6,6,7,7,8,8,9,9,10,10,11,11,12,12-eicosafluoro-dodecyl (meth)acrylate, and the like, for example 1H, 1H, 3H-hexafluorobutyl acrylate.

For the avoidance of doubt, the fluorinated acrylates mentioned herein may be used alone or in any technically sensible combination.

Surfactants Surfactants lowers the surface tension between two liquids, between a gas and a liquid, or between a liquid and a solid. Surfactants may act as emulsifiers, foaming agents, detergents, wetting agents, and dispersants Suitable surfactants include anionic, nonionic, cationic, amphoteric, silicon, fluorinated, and polymeric surfactants or the like. Zwitterionic surfactants could also be used. The content of surfactants in the compositions may be in the range of 0.1% to 10% by weight (wt/wt: %) of the total composition and preferably in the range of 0.8-6 wt/wt %.

In embodiments, suitable surfactant include, but are not limited to: polyoxyethylene alkyl ethers such as polysorbate 40 (e.g. polysorbate 40 with a molecular weight of 1,080-1,480 Tween™ 40), polysorbate 60 (e.g. polysorbate 60 with a molecular weight of 1,100-1,500 g/mol, Tween™ 60), polysorbate 65 (e.g. polysorbate 65 with a molecular weight of 1,680-2,080 g/mol, Tween™ 65), polysorbate 80 (e.g. polysorbate 80 with a molecular weight of 1,100-1,500 g/mol, Tween™ 80), Polyethylene glycol p-(1,1,3,3-tetramethylbutyl)-phenyl ether (e.g. Polyethylene glycol p-(1,1,3,3-tetramethylbutyl)-phenyl ether with a molecular weight of 550-700 g/mol, Triton™ X-100 or Triton™ X-10); Polyether-modified polydimethylsiloxane based surface additives; polyoxyethylene esters such as Sorbitan monolaurate (e.g. Sorbitan monolaurate with a molecular weight of 300-400 g/mol, Span™ 20), Sorbitan monopalmitate (e.g. Sorbitan monopalmitate with a molecular weight of 350-450 g/mol, Span™ 40), Sorbitan monostearate (e.g. Sorbitan monostearate with a molecular weight of 350-500 g/mol, Span™ 60) and sorbitan monooleate (e.g. sorbitan monooleate with a molecular weight of 1,100-1,500 g/mol, Span™ 80); polyoxyethylene alkyl phenol condensates such as Peregal 0-10 (fatty alcohol polyoxyethylene ether 0-10), Peregal 0-25 (fatty alcohol polyoxyethylene ether 0-25) and Peregal A-20 (fatty alcohol polyoxyethylene ether A-20); and solvent free fluorosurfactants.

Other examples of suitable surfactants are provided below.

Examples of suitable anionic surfactants include salts of alkyl sulfates having from 8 to 20 carbon atoms in the alkyl radical, such as sodium alkyl sulfate, and salts of sulfonated monoglycerides of fatty acids having from 8 to 20 carbon atoms, Sodium lauryl sulfate (SLS) and sodium coconut monoglyceride sultanates, sarcosinates, taurates, isethionates, sodium lauryl sulfoacetate, sodium laureth carboxylate and sodium dodecyl benzeenesulfonate, alkali metal or ammonium salts of surfactants such as the sodium and potassium salts of lauroyl sarcosinate, myristoyl sarcosinate, palmitayl sarcosinate, stearoyl sarcosinate, and oleoyl sarcosinate.

Examples of suitable cationic surfactants include derivatives of aliphatic quaternary ammonium compounds having at least one long alkyl chain containing from about 8 to about :1.8 carbon atoms, such as, lauryl trimethylammonium chloride, cetyl pyridinium chloride, cetyl trimethylammonium bromide, di-isobutylphenoxyethyldimethylbenzylammonium chloride, coconut alkyltrimethylammonium nitrite, cetyl pyridinium fluoride and blends thereof.

Examples of suitable nonionic surfactants include poloxamers (Pluronic™ by BASF), polyethylene oxide condensates of alkyl phenols, products derived from the condensation of ethylene oxide with the reaction product of propylene oxide and ethylene diamine, ethylene oxide condensates of aliphatic alcohols, long chain tertiary amine oxides, long chain tertiary phosphine oxides, long chain dialkyl sulfoxides, and blends thereof.

Examples of suitable zwitterionic surfactants include betaines and derivatives of aliphatic quaternary ammonium compounds in which the aliphatic radicals can be straight chain or branched, and which contain an anionic water-solubilizing group such as carboxy, sulfonate, sulfate, phosphate, or phosphonate.

In particular embodiments solvent free fluorosurfactants, and/or polyether-modified polydimethylsiloxane based surface additives may be used as the surfactant.

For the avoidance of doubt, the surfactants mentioned herein may be used alone or in any technically sensible combination.

Additives

In certain embodiments, various additives are added to the compositions. The content of additives in the composition may be in the range of 1% to 15% by weight (wt/wt %) of the total compositions and preferably in the range of 3.5-10 wt/wt %.

Examples of these additives include, but are not limited to, pigments, antioxidants, compatihilizers, thermal and UV stabilizers, inorganic and organic fillers, plasticizers, nucleating agents, anti-slip agents, anti-blocking agents, flame retardants, radical scavengers, anti-microbial agents, an ultraviolet (UV) absorber, antioxidant, air release agent, plasticizer, antistatic agent, soldering resistance agent, anti-drip agent, coupling agent, thixotropic agent, anti-foaming additive, anti-settling agent, adhesion promoter, organic wax, surfactant and wetting agent.

Such additives can be added at any suitable time during combination of the components to form the composition. Antistatic agents such as ethoxylated alkyl amines and fatty acid esters may be used. Examples of suitable fatty acids include myristic acid, palmitic acid, stearic acid, behenic acid, oleic acid, linoleic acid, isostearic acid, and blends thereof. The derivatives of fatty acids include carboxylic ester acids including mono-, di-, tri- and tetra- carboxylic acids esters, amides, anhydrides, esteramides, imides, and mixtures of these functional groups.

Suitable UV stabilizers may include, but are not limited to 4-methoxyphenol, butylated hyrdorxytoluene (2,6-di-t-butyl-4-methylphenol), phenothiazine, bistridecylthiodipropionate, ethoxylated alkyl amine and hinder amines.

In some embodiments, suitable flame retardants may include, but are not limited to, a nitrite, a nitride, a borate, a silicide, a silicate, an antioxidant compound, and/or combinations thereof.

Examples of nitrides include alkali metal nitrides and alkaline earth nitride.

Examples of borates include alkali metal borates and alkaline earth borates.

Examples of silicides include alkali metal silicides and alkaline earth silicides.

Examples of silicates include alkali metal silicates and alkaline earth silicates.

Examples of antioxidants include compounds such as amino acids (e.g., glutathione) and alkali or alkaline earth salts thereof, polyphenols, carotenoids, tocotrienols, ascorbic acid and alkali or alkaline earth salts thereof, lipoid acid and alkali or alkaline earth salts thereof; and/or combinations thereof. Other suitable antioxidants include , BHA (tert-butyl 4hydroxy anisole), BHT (2,6-di-tert-butyl-cresol), TBHQ (t-butyl hydroquinone), polyphenols such as proanthocyanodic oligomers, flavonoids, hindered amines such as tetra amino piperidine, erythorbic acid, polyamines such as spermine, cysteine, glutathione, superoxide dismutase, lactoferrin, and blends thereof.

In some embodiments, suitable flame retardants may be used which include, but are not limited to 2-2′-hydroxy-3′-(3″,4″,5″,6″-tetraphthalimidomethyl)-5′-methylphenyl, benzotriazole and 2,2′-dihydroxy-4,4′-dimethoxybenzophenone.

In some embodiments, suitable anti-oxidants may include, but are not limited to, alkylated monophenols, alkylated hydroquinones, hydroxylated thiodiphenyl ethers, alkylidene-bisphenols, hindered phenolic benzyl compounds, acylaminophenols, esters of 3-(3,5-di-t-butyl-4-hydroxyphenyl)propionic acid, esters of 3-(5-t-butyl-4-hydroxy-3-methylphenyl)propionic acid, 3-(3,5-di-t-butyl-4-hydroxyphenyl)propionic acid amides.

In some embodiments, suitable UV absorbers and light stabilizers may include, but are not limited to, 2-hydroxybenzophenones, benzylidene malonate esters, fatty acid ester, esters of substituted or unsubstituted benzoic acids, diphenyl acrylates, nickel chelates, oxalic acid diamides, and hindered amine light stabilizers. Specific suitable UV absorbers and light stabilizers include, octyl salicylate, pentyl dimethyl PABA, octyl dimethyl PABA, benzophenone- 1, benzophenone-6,2-(2H-benzotriazole-2-yl)-4,6-di-tert-pentylphenol, ethyl-2-cyano-3,3-diphenylacrylate, homomenthyl salicylate, bisethylhexyloxyphenol methoxyphenyl triazine, methyl-(1,2,2,6,6-pentamethyl-4-piperidyl)-sebacate, 2-(2H-benzotriazole-2-yl)-4-methylphenol, diethylhexyl butamido triazone, amyl dimethyl PABA, 4,5-bis(octylthiomethyl)-o-cresol, ethylhexyl triazone, octocrylene, isoamyl-p-methoxycinnamate, drometrizole, titanium dioxide,2,4-di-tert-butyl-6-(5-chloro-2H-benzotriazole-2-yl)-phenol, 2-hydroxy-4-octyloxybenzophenone, benzophenone-2, diisopropyl methylcinnamate, PEG-25 PABA, 2-(I,Idimethylethyl)-6-[3-(I,I-demethylethyl)-2-hydroxy-5-methylphenyl]methyl-4-methylphenyl acrylate, drometrizole trisiloxane, menthyl anthranilate, butyl methoxydibenzoylmethane, 2-ethoxyethyl p-methoxycinnamate, benzylidene camphor sulfonic acid, dimethoxyphenyl-[I-(3,4)]-4,4-dimethyl 1,3-pentanedione, zinc oxide, N,N′-hexane-I,6-diylbis[3-(3,5-di-tert-butyl-4-hydroxyphenylpropionamide)], pentaerythritol tetrakis[3-(3,5-di-tert-butyl-4-hydroxyphenyl) propionate], 2,6-di-tert-butyl-4-[4,4,6-bis(octylthio)-1,3,5-triazin-2-ylalmino] phenol, 2-(2H-benzotriazole-2-yl)-4,6-bis(1-methyl-1-phenylethyl)phenol, trolamine salicylate, diethylanolamine p-methoxycinnamate, polysilicone-15, 4-triethylbenzyldene camphor, bisoctrizole, n-phenyl-benzenamine, reaction products with 2,4,4-trimethylpentene, sulisobenzone, (2-ethylhexyl)-2-cyano-3,3-diphenylacrylate, digalloyltrioleate, polyacrylamide methylbenzylidene camphor, glyceryl ethylhexanoate dimethoxycinnamate, 1,3-bis-[(2′-cyano-3′,3″-diphenylacryloyl)oxy]-2,2-bis-[(2′-cyano-bis-(2,2,6,6-tetramethyl-4-piperidyl)-sebacate, benzophenone-5; I,3,5-tris(3,5-di-tert-butyl-4-hydroxybenzyl)-1,3,5-triazine-2,4,6(IH,3H,5H)-trione, hexamethylendiamine, benzophenone-8, ethyl-4-bis(hydroxypropyl) aminobenzoate; 6-tert-butyl-2-(5-chloro-2H-benzotriazole-2-yl)-4-methylphenol, p-aminobenzoic acid, 3,3′,3″,5,5′,5″-hexa-tert-butyl-a-a′-a″-(mesitylene-2,4,6-triyl)tri-cresol, lawsone with dihydroxyacetone, benzophenone-9, benzophenone-4, ethylhexyldimethoxy benzylidene dioxoimidazoline propionate, N,N′-bisformyl-N,N′-bis-(2,2,6,6-tetramethyl piperidinyl)-, 3-benzylidene camphor, terephthalylidene dicamphor sulfonic acid, camphor benzalkonium methosulfate, bisdisulizole disodium, etocrylene, ferulic acid, 2-(2Hbenzotriazole-2-yl)-4-(1,1,3,3-tetramethylbutyl)-phenol, 4,6-bis(dodecylthiomethyl)-o-cresol, □-2-glucopyranoxy propyl hydroxy benzophenone, phenylhenzimidazole sulfonic acid, benzophenone-3, diethylamine hydroxybenzoyl hexylbenzoate, 3′,3′-diphenlylacryloyl)oxy] methyl; -propane, ethylhexyl p-methoxycinnamate and blends thereof.

Other additives such as lubricating agents Zonyl MP 1000 Fluoroadditive, Zonyl MP 1100 Fluoroadditive, and Zonyl MP 1300 Fluoroadditive, are commercially available from Du Pont Company.

For the avoidance of doubt, the additives mentioned herein may be used alone or in any technically sensible combination.

Fillers

Fillers are particles added to compositions to lower the consumption of more expensive binder material or to better some properties of the material. The content of fillers in the composition may be in the range of 0.5% to 5% by weight (wt/wt %) of the total compositions and preferably in the range of 0.5-3.5 wt/wt %.

Examples of fillers include, but are not limited to, particulate filler (e..g., silica, talc, calcium carbonate, clays, or calcium silicate), a fibrous reinforcement (e.g. glass fibers), inorganic and organic fillers such as titanium dioxide (rutile and anatase), barium titanate, strontium titanate, silica, including fused amorphous silica, corundum, wollastonite, aramide fibers (e.g., KEVLAR™ from DuPont), fiberglass; POSS (solid or liquid), glass particles, glass spheres, quartz, boron nitride, aluminum nitride, silicon carbide, beryllia, alumina, magnesia, magnesium hydroxide, mica, talcs, nanoclays, aluminum trihydroxide, ammonium polyphosphate, melamine polyphosphate, boehmite aluminum phosphinate, potassium titanate, aluminum borate, cyanurates, phosphates, aluminosilicates (natural and synthetic), fumed silicon dioxide and combinations thereof.

Other suitable fillers include silicas such as gels and precipitates, insoluble sodium polymetaphosphate, hydrated alumina, calcium carbonate, dicalcium orthophosphate dihydrate, calcium pyrophosphate, tricalcium phosphate, calcium polymetaphosphate and blends thereof.

The fillers can be in the form of solid, porous, or hollow particles. The particulate filler can be in any configuration including spheres, whiskers, fibers, particles, plates, acicular, flakes, or irregular shapes.

The average particle size of the particulate filler may range from 1 nm to 1 mm. To improve adhesion between the fillers and polymer, the filler can be treated with one or more coupling agents, such as silanes, zirconates, or titanates.

For the avoidance of doubt, the fillers mentioned herein may be used alone or in any technically sensible combination.

Colourants

The composition may also include colourants such as pigments and dyes used individually or in combination. The content of colourants in the composition may be in the range of 0.01% to 2% by weight (wt/wt %) of the total compositions and preferably in the range of 0.02-1 wt/wt %.

A variety of dyes are suitable for use as a colorant component. Suitable dyes may include those having a chromophore and/or a fluorophore. Suitable colourants may include, but are not limited to, phthalocyanine dye, an acid dye, a basic dye, an azo dye, an anthroquinone dye, a naphthalimide dye, a coumarin dye, a Xanthene dye, a thioxanthene dye, a naphtholactam dye, an azlactone dye, a methine dye, an oxazine dye, a thiazine dye, a triphenylmethane dye, a reactive dye, a direct dye, a vat dye, a sulfur dye, a disperse dye, a mordant dye, and a fluorescent dye. Examples of dyes are and not limited to, Iron Oxide Yellow, Bismuth Vanadium Oxide, Transparent Iron Oxide, Sicotrans Red, Titanium Dioxide, Red Quinacridone, Monastral Red, Quinacridone Magenta, Benzimidazolone AZO Hostaperm Yellow, Perylene Maroon, Perrindo Maroon, Diketo Pyrrolopyrrol Irgazin DEW Red, Quinacridone Violet, Blue Copper Phthalo Irgazin Blue, Green Copper Phthalo Sunfast Green, Endurophthal Blue, HDDA (Hexandiol diacrylate) based pigments, TMPEOTA (Ethoxylated trimethylolpropane triacrylate) based pigments, Carbon black, C. I. Pigment Yellow 1, C. I. Pigment Yellow 3, C. I. Pigment Yellow 12, C. I. Pigment Yellow 13, C. I. Pigment Yellow 14, C. I. Pigment Yellow 34, C, I. Pigment Yellow 36, C. I. Pigment Yellow 65, C. I. Pigment Yellow 74, C. I. Pigment Yellow 81, C. I. Pigment Yellow 83, C. I. Pigment Orange 13, C. I. Pigment Orange 16, C. I. Pigment Orange 34, C. I. Pigment Red 3, C. I. Pigment Red 8, C. I. Pigment Red 21, C. I. Pigment Red 7, C. I. Pigment Red 23, C. I, Pigment Red 38, C. I. Pigment Red 48:2, C. I. Pigment Red 48:4, C. I. Pigment Red 49:1, C. I. Pigment Red 52:2, C. I. Pigment Red 57:1, C. I. Pigment Red 63:1, C. I. Pigment Red 64:1, C, I, Pigment Red 81, C. I. Pigment Red 88, C. I. Pigment Red 92, C. I. Pigment Red 101, C. I. Pigment Red 104, C. I. Pigment Red 105, C. I. Pigment Red 106, C. I. Pigment Red 108, C. I. Pigment Red 112, C. I. Pigment Red 122, C. I. Pigment Red 123, C. I. Pigment Red 146, C, I, Pigment Red 149, C. I. Pigment Red 166, C. I. Pigment Red 168, C. I. Pigment Red 170, C. I. Pigment Red 172, C. I. Pigment Red 185, C. I. Pigment Red 190, C. I. Pigment Red 209, C. I. Pigment Red 219, C. I. Pigment Blue 1, C. I. Pigment Blue 15:1, C. I. Pigment Blue 15:3, C. I. Pigment Blue 15:4, C. I. Pigment Blue 15:6, C. Pigment Blue 16, C. I. Pigment Blue 17:1, C. I. Pigment Blue 56, C. I, Pigment Blue 61, C. I, Pigment Blue 63 and C. I. Pigment Purple 19. In particular embodiments that may be used herein, the colourants based on HDD: (Hexandiol diacrylate) and/or TMPEOTA (Ethoxylated trimethylolpropane triacrylate) may be used.

In addition to colourants, the composition may also include a pigment extender and/or colour stabilizer. For the avoidance of doubt, the colourants mentioned herein may be used alone or in any technically sensible combination.

Specific examples of the different types of curable compositions useful for making additively manufactured (e.g. 3D printed) dental models are depicted in Table 1. Other process parameters such a mixing speed, batch mixing time, temperature, pressure, pH or degassing may be used to control various properties including homogeneity and consistency of the formulation where necessary.

TABLE 1
Examples of different curable compositions suitable for making additively manufactured (e.g.
3D printed) dental models.

| Composition | | | | | |
|---|---|---|---|---|---|
| in wt/wt % | Example 1 | Example 2 | Example 3 | Example 4 | Example 5 |
| Acrylate/ | Bisphenol A- | Mono- | Trifunctional | Trifunctional | Bisphenol A |
| Methacrylate | glycidyl | functional | acrylate (18) | acrylate (10) | epoxy |
| (monomer/ | methacrylate | methacrylate | Bisphenol A | Multifunctional | dimethacrylate |
| oligomer) | (20) | (15) | epoxy | acrylate | (24) |
| | Difunctional | Bisphenol A | dimethacrylate | (20) | Propoxylated |
| | acrylate (10) | epoxy | (22) | Monofunctional | neopentyl |
| | Bisphenal A | dimethacrylate | Bisphenol A | methacrylate | glycol |
| | epoxy | (20) | epoxy | (13) | diacrylate (9) |
| | methacrylate | Propoxylat-ed | methacrylate | Propoxylated | |
| | (14) | neopentyl | (16) | neopentyl | |
| | | glycol | | glycol | |
| | | diacrylate (4) | | diacrylate (8) | |
| Reactive | Isobornyl | Triethylene | Isobornyl | Isobornyl | Isobornyl |
| diluent | acrylate (10) | glycol | acrylate (10) | methacryla-te | methacrylate |
| | Isobornyl | dimethacrylate | Isobornyl | (16) | (16.5) |
| | methacrylate | (8) | methacrylate | Triethylene | |
| | (13) | Isobornyl | (13) | glycol | |
| | | acrylate (5) | | dimethacrylate | |
| | | Isobornyl | | (10) | |
| | | methacrylate | | | |
| | | (10) | | | |
| Epoxy/Urethane | Aliphatic | Aromatic | Aliphatic | Modified | Aliphatic |
| acrylate | Urethane | Urethane | Urethane | Bisphenol-A | urethane |
| (monomer/ | Tetraacrylate | Hexaacrylate | methacrylate | Epoxy | diacrylate |
| oligomer) | (5) | (5) | (3) | Diacrylate (2) | (6.5) |
| | Difunctional | Hexa- | Aliphatic | Aliphatic | Difunctional |
| | bisphenol A | functional | Urethane | Urethane | bisphenol A |
| | epoxy | aliphatic | Triacrylate | Hexaacrylate | epoxy |
| | methacrylate | urethane | (1) | (2) | methacrylate |
| | (3) | acrylate (5) | | | (6.5) |
| Silicone | Silicone | Aliphatic | Aliphatic | Aliphatic | Aliphatic |
| Acrylate | polyester | siliconized | siliconized | siliconized | siliconized |
| | acrylate | urethane | urethane | urethane | urethane |
| | (8) | acrylate | acrylate | acrylate | acrylate |
| | | (2) | (4.5) | (4.5) | (8) |
| | | Silicone | | | Silicone |
| | | polyester | | | polyester |
| | | acrylate | | | acrylate |
| | | (4) | | | (16) |
| Fluoro | 1H, 1H, 3H- | 1H, 1H, 3H- | 1H, 1H, 3H- | 1H, 1H, 3H- | 1H, 1H, 3H- |
| Acrylate | hexafluoro- | hexafluoro- | hexafluoro- | hexafluoro- | hexafluoro- |
| | butyl | butyl acrylate | butyl | butyl acrylate | butyl |
| | acrylate (5) | (5) | acrylate | (3.5) | acrylate |
| | Trifluoro | Perfluoro | (4.0) | | (5) |
| | ethyl | polyether | | | |
| | methacrylate | acrylate (2.5) | | | |
| | (3) | | | | |
| Surfactant | Polyether- | Polyether- | Polyether- | Polyether- | Polyether- |
| | modified, | modified | modified | modified | modified |
| | acryl- | PDMS based | PDMS based | PDMS based | PDMS based |
| | functional | surface | surface | surface | surface |
| | polydimethyl | modifier (0.5) | modifier | modifier (0.5) | modifier |
| | siloxane (0.5) | (0.5) | | Fluoro- | (1) |
| | Fluoro- | | | surfactant | Fluoro- |
| | surfactant | | | (0.5) | surfactant |
| | (0.5) | | | | (5) |
| Additives | Ethoxylated | Ethoxylated | 4,6- | Ethoxylated | Ethoxylated |
| | alkyl amine | alkyl amine | bis(octylthio | alkyl amine | alkyl amine |
| | (5) | (5) | methyl)-o- | (3.5) | (4) |
| | | Fatty acid | cresol (2) | | Fatty acid |
| | | ester | Ethoxylated | | ester |
| | | (5) | alkyl amine | | (4) |
| | | | (2) | | |
| | | | Fatty acid | | |
| | | | ester | | |
| | | | (1) | | |
| Colorant | UV- | Brilliant blue | Green azo | UV-responsive | UV |
| | responsive | FCF dye (0.08) | dye (0.05) | pigment-white | responsive |
| | pigment- | UV responsive | UV- | (0.5) | pigment-blue |
| | white | pigment-blue | responsive | | (0.025) |
| | (0.35) UV | (0.12) | pigment- | | UV- |
| | responsive | UV-responsive | white (0.45) | | responsive |
| | pigment-blue | pigment-white | | | pigment- |
| | (0.15) | (0.3) | | | white |
| | | | | | (0.15) |
| Photoinitiator | Diphenyl | Diphenyl | Diphenyl | 1-Hydroxy- | Diphenyl |
| | (2,4,6- | (2,4,6- | (2,4,6- | cyclohexyl- | (2,4,6- |
| | trimethyl | trimethyl | trimethyl | phenyl-ketone | trimethyl |
| | benzoyl)- | benzoyl)- | benzoyl)- | (0.5) 5,7- | benzoyl)- |
| | phenyl | phenyl | phenyl | diiodo-3- | phenyl |
| | phosphine | phosphine | phosphine | butoxy-6- | phosphine |
| | oxide (1.5) | oxide (1.0) | oxide (0.5) | fluorone (2) | oxide (1.5) |
| | Phenylbis | 1-Hydroxy- | | | Phenylbis |
| | (2,4,6- | cyclohexyl- | | | (2,4,6- |
| | trimethyl | phenyl-ketone | | | trimethyl |
| | benzoyl)- | (0.25) | | | benzoyl)- |
| | phenyl | 5,7-diiodo-3- | | | phenyl |
| | phosphine | butoxy-6- | | | phosphine |
| | oxide | fluorone | | | oxide |
| | (1.0) | (0.25) | | | (0.8) |
| Filler | — | Melamine | Melamine | Melamine | — |
| | | cyanurate | phosphate | polyphosphate | |
| | | (0.5) | (1) | (3.5) | |
| | | Polyhedral | Tetraethyl | | |
| | | Oligomeric | Orthosilicate | | |
| | | Silsesquioxane | (1) | | |
| | | (0.5) | | | |

The following test methods were used to characterize various parameters of the dental models. The curable composition properties were analysed using FTIR, viscometry and colour spectrometry measurements. For the 3D printed object measurements, the test specimens were 3D printed on a Structo MSLA platform (Orthoform, Dentaform) based 3D printer to fabricate the samples required for each category of characterization namely contact angle, tensile test, flexure test, hardness test and DMA analysis, Other forms of 3D printing such as Laser SLA, DLP-SLA, LCD-SLA, Polyjet, Inkjet, CLIP techniques may be used to 3D print the test specimens as well. Contact angle measurement was used to substantiate and evidence the non-adhesive surface properties of the material. Mechanical property characterization was performed to assess the tensile, flexural and hardness attributes of the material. Thermal property (Tg) of the material was analysed using Dynamic Mechanical Analysis (DMA) to withstand heat during the pressure pot steps associated with some orthodontic device manufacturing techniques (e.g. S&P).

FTIR

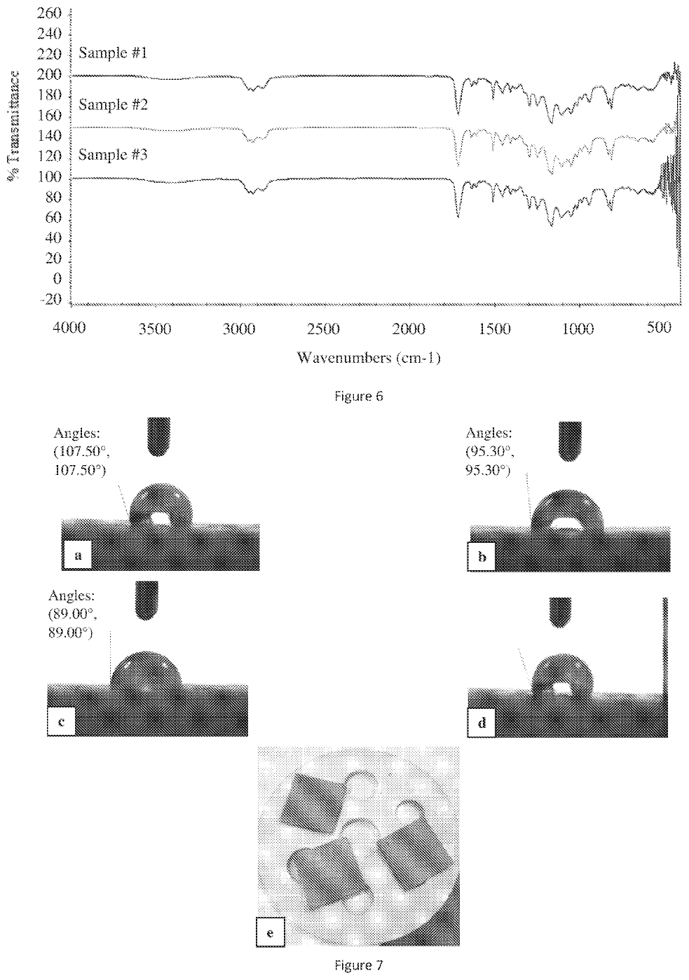

Fourier Transform Infrared Spectroscopy (FTIR) is an analytical technique used to identify polymeric materials. The FTIR analysis method uses infrared light to scan test samples and displays different chemical signature peaks. A material's absorbance of infrared light at different frequencies produces a unique spectral fingerprint based upon the frequencies at which the material absorbs infrared light and the intensity of those absorptions. In this method, in preparation for measurement, the curable composition is prepared and enough liquid is pipetted to fully cover the diamond crystal (black dot) at the centre of the FTIR spectrometer. The instrument is run to measure the absorbance of the formulation accordingly. The resulting spectral scan depicting absorbance or transmittance is measured to verify consistency of a curable composition. The FTIR spectra for three samples of the curable composition of Example 1 are shown in FIG. 6. Highly reproducible and consistent results were obtained from the FTIR analysis signifying homogeneity in the curable composition of Example 1.

Viscosity

Viscosity, a measure of the internal friction of a fluid, is determined by calculating the shear force required for moving through the fluid. Shearing occurs when the fluid is physically mixed or dispersed using a spindle. By means of the torque arising from the relative movement of the spindle inside the fluid and by using some parameters related to the spindle geometry, angular velocity and chamber geometry, viscosity is measured. For measurement, a curable composition is prepared in 250 ml glass beaker. The beaker is placed under the viscometer and the knob was slowly rotated until the liquid surface mark on the spindle was submerged below the surface of the curable composition. The measurements are made at 30 RPM using SPL2. The viscosity value is recorded once the instrument has reached steady state as shown in Table 2 below. The viscosity readings are well within the acceptable range of value required for the curable composition to be usable in an additive manufacturing (e.g. 30 printing) process.

TABLE 2
Viscosity measurement values for the
curable composition of Example 2.

| Characteristic | Results in mPa · s | Torque % |
|---|---|---|
| Viscosity at 23° C. | 769.5 | 77.0 |

Colour Spectrophotometry

Colour spectrophotometry is a useful tool to measure colour consistency of materials. It involves the interaction of matter with electromagnetic (EM) radiation where the instrument measures the visible portion of the EM spectrum. The spectrophotometer is used to find the absorption of dyes and pigments used in the formulation and thereby verify the colour consistency across multiple batches. Approximately 25 ml of the curable composition is measured in a cuvette and placed on the sensor aperture of the spectrophotometer after calibration. Colour spectra readings are obtained for a minimum of 3 samples. The absorbance/transmittance values of the colour measurement are tabulated below in Table 3. The results show good colour consistency and reproducibility across the various batches.

TABLE 3
Colour measurement for three samples
of the curable composition of Example 2 and their
corresponding L*a*b (where, L = co-ordinate
position for lightness of colour, a = co-ordinate position
between red and green, b = co-ordinate position
between yellow and blue, respectively
on colour space graph).

| Sample | L, a, b values |
|---|---|
| Example 2 | L: 52.52; a: −21.61; b: −12.76 |
| Example 2 | L: 52.48; a: −21.60; b: −12.76 |
| Example 2 | L: 52.39; a: −21.63; b: −12.76 |

Contact Angle

All samples used in the following tests are 3D printed or made with Structo MISLA printers using the composition of the invention. In the Contact Angle test, the objective of this analysis is to study the hydrophobicity of the material by measuring contact angle of water on the sample. The 3D printed sample as shown in FIG. 7(e), is placed on the platform of the instrument. A small amount of water (1 μl) was dispensed with syringe, on the curable compositions of Examples 1, 2 and 3. The contact angle of the water is measured and a higher contact angle denotes higher hydrophobicity of the surface. Three data points were measured per sample. The contact angle range for the batch of samples was 85°-110°. A comparison of this range to the contact angle measurement performed on a separator film in FIG. 7(d) shows that the 3D printed dental models of the invention exhibit a more hydrophobic surface which is conducive for the non-adhesiveness and non-reactivity with the acrylic mixture used during preparation or fabrication of an orthodontic appliance.

Tensile Test

The dog bone shaped 3D printed test specimen was measured with the callipers to determine the cross section, gauge length and scribed into the specimen so that the distance between the two marks could be measured after the tensile test was completed. The specimen was loaded into the jaws of the load frame so that it was equally spaced between the two damps. The specimen was properly loaded in the frame and ensured that it was not slipping in the jaws. The test was started, and the specimen was loaded, resulting in a measurable strain until fracture. BS EN ISO 527-1:1996, Plastics-Determination of Tensile Properties, was used as the standard protocol. The key metrics according to the standard measurement are as follow: nominal specimen dimensions (5 nm×10 mm (fracture area)), gauge length (50 mm), length of grips separation (149.60 mm), crosshead speed (1 mm/min), no. of determinations (5).

TABLE 4
Tensile property measurements of a 3D
printed dental model prepared using
the composition of Example 1.

| Characteristics | Value | Unit |
|---|---|---|
| Tensile Strength | 12-18 | MPa |
| Tensile Modulus | 290-350 | MPa |
| Elongation to break | 9-14 | % |

Flexure Test

A bar of rectangular cross section was 3D printed on Structo MSLA 3D printer using the curable composition of Example 1, The bar was made to rest on two supports and was loaded by means of a loading nose midway between the supports, A support span-to-depth ratio of 16:1 was used, The specimen was deflected until rupture occurred in the outer surface of the test specimen. BS EN lSO 178:2010+A1:2013, Plastics-- Determination of Flexural Properties, was used as the standard protocol. The key metrics according to the standard measurement are as follow: nominal specimen dimensions (79.6 mm×10 mm×4.6 mm), support span length (60 mm), crosshead speed (1.30 mm/min) and no. of determinations (5).

TABLE 5
Flexural property measurements of a 3D printed bar
prepared from the curable composition of Example 1.

| Characteristics | Value | Unit |
|---|---|---|
| Flexural Strength | 14-17 | MPa |
| Flexural Modulus | 850-926 | MPa |
| Elongation to break | 27-34 | % |

Hardness Shore D

The method enables hardness test based on initial indentation or indentation after a specified period of time or both. With Shore D, the point of the steel dent penetrates into the material. The depth of indentation or penetration was measured on a scale of 0 to 100. Because of the resilience of plastics, epoxys and acrylic, the hardness reading may change over time so the indentation time is sometimes reported along with the hardness number. BS EN ISO 868:2003, Plastics and Ebonite- Determination of indentation hardness by means of a durometer (Shore Hardness), was used as the standard protocol. The key metrics according to the standard measurement are nominal specimen thickness (6 mm), time interval for each reading (10 sec), no. of determinations (10).

TABLE 6
Shore D Hardness measurements of 3D printed sample
prepared from the curable composition of Example 1.

| Characteristics | Value | Unit |
|---|---|---|
| Hardness | 70-80 | Shore D |

Dynamic Mechanical Analysis

The Dynamic Mechanical Analysis is to study the thermal properties of the cured composition using

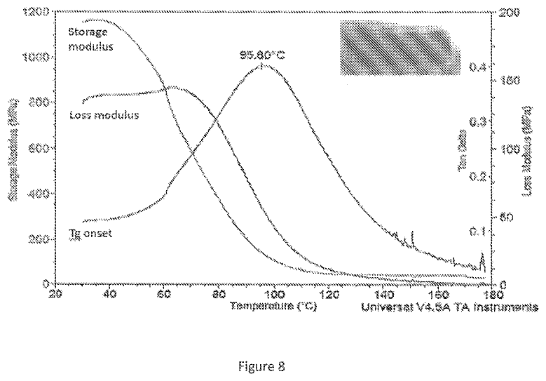

Dynamic mechanical analysis (DMA). DMA is used to study viscoelastic properties of polymer at various temperatures, including the dynamic moduli. The study method also accurately determines the Tg, which is the temperature at which the polymer softens. Using a single cantilever fixture, 3D printed samples (image as shown in inset of FIG. 8) were heated to 180° C. at rate of 3° C./min in air atmosphere. The onset of Tg was at around 65° C. and peak Tg was observed at around 96° C. At the same time, the stiffness based on storage modulus was measured to be approximately 1000-1200 MPa respectively.

Water Sorption

Water Sorption test of the polymer material is performed to assess the water permeability and absorption characteristics of the material. The study represents a quantitative investigation based on the interaction between water and the polymeric material. The study protocols are followed as per ISO 1567:2000. Samples are dried initially at 37° C. for 24 hours and then cooled to 25° C. for the measurement. Measurements are conducted daily till the sample weight is consistent. Samples are then placed in a thermal bath at 37° C. for 7 days and the weight of the samples are measured. Drying is performed again similar to the initial step and the dry sample weight is measured again once the value is consistent. The difference in mass is subsequently measured to arrive at the amount of water absorbed which is 26.4 μg/mm³.

Biocompatibility

Biocompatibility is a general term describing the property of a material being compatible with living tissue. Biocompatible materials should not produce a toxic or immunological response when exposed to the human body or bodily fluids. In this context, the orthodontic appliances manufactured using the dental model may be required to be biologically safe since they are exposed intermittently or long term to the human body or body fluids. To verify the effects of toxicity of both the dental model and the orthodontic appliances (e,g. HRs) manufactured using the dental model, the samples were subjected to cytotoxicity test according to ISO 10993 (Biological evaluation of medical devices Part 5 Tests for in vitro cytotoxicity, Third edition: 2009-06-01. L929 cells (ATCC CCL 1; NCTC clone 929, Connective tissue, mouse). Cell suspension of approximately 105 cells per ml prepared in culture medium was transferred to each well of the 6-well plates. The plates were incubated at 37° C. for 24 to 48 hours until subconfluent monolayer was formed. The subconfluency and the morphology of the cultures were verified by microscopic observation prior to the start of the test. The test item extract and extracts of Positive and Negative controls were used immediately for testing after the preparation. All tests were performed in triplicates. After incubation, the culture medium from the subconfluent monolayer was removed and replaced by aliquots of the extracts of the test item, positive and negative controls in each of the wells respectively. The plates were incubated at 37° C. for 48 hours in a humidified incubator containing 5% carbon dioxide. At 48 hours of incubation, the cell culture plates were examined microscopically at a magnification of 100×. The degree of cytotoxicity of the extracts observed in each well was graded. Based on the requirement of the test standard and the results of analysis, both the dental model as well as the orthodontic appliances manufactured from it were found to have no cytotoxic effect and were graded 0 for reactivity in the reactivity zone chart.

3D Scan Accuracy

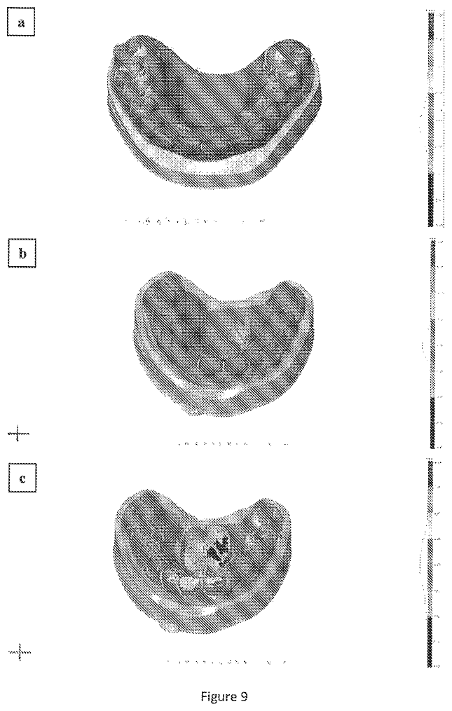

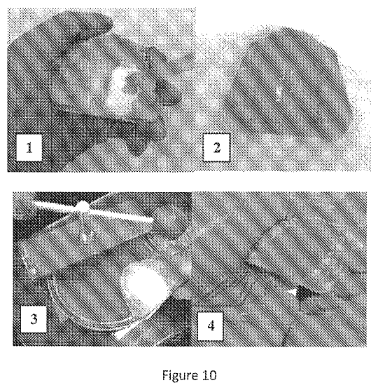

3D scanning is used to create a virtual 3D image of a printed object. The virtual image can then be compared to the original CAD file for accuracy measurements. This 3D scan consists of a point cloud of geometric samples on the surface of the subject. Multiple scans are required for detailed accuracy, repeatability and uniformity measurements of various dental models. For various dental/orthodontic applications, different accuracy tolerances are required to be met to sustain the workflow requirements. Keeping that in mind, the accuracy tolerances for the 3D printed dental models were assessed (FIG. 9) for three sets of tolerance requirements (i) 100 μm (1σ), (ii) 100 μm (2σ) and (iii) 50 μm (1σ) for a minimum of two determinations each. All of the three accuracy tolerance criteria were sufficiently met for the 3D printed dental models.

Single Use vs Multiple Use Cycles

The 3D printed dental models were subjected to multiple routines of Hawley Retainer manufacturing cycles to ensure that the surface non-adhesion property is retained. The models can sustain acrylic non-bonding property for single use and multiple use (up to 3 tested cycles). This demonstrates that a dental model prepared from the curable composition can be used to prepare multiple orthodontic appliances for the same patient.

Fabrication of Dental Models and Orthodontic Appliances

Orthodontic appliances can be prepared using additive manufactured 3D printed dental models as described below.

Before the formation of the dental model, the intraoral anatomy of the patient may be scanned to create a virtual 3D anatomical model of the patient's mouth. This scan can be converted into a patient specific digital file designed with necessary details of the end dental appliance. The appropriate support structures can be designed and the printable digital file be arranged in the nesting software.

Then, the dental model or a combination of models can be prepared by additive manufacturing (e.g. 3D printing), singularly or simultaneously.

The formation of an orthodontic appliance is then performed on the dental model. As an example, the orthodontic appliance can be a Hawley Retainer. A Hawley Retainer can be prepared according to the following procedure. Wire bending and keeper wires can be arranged along loop lines. Next, hot wax or glue can be applied and the wires soldered in place using a solder flame, iron or laser. If using the salt and pepper method, powder, liquid and colour can be applied, followed by pressure cooking under water at 45-55° C., 10-25 psi for 10-20 minutes. The Hawley Retainer can be easily removed from the dental model by placing a knife under the acrylic. Finally, the finish can be completed and the retainer filed to smoothen the edges.

As an example of a method of forming an orthodontic appliance, the salt & pepper technique is described below.

Firstly the monomer powder is evenly spread and then the polymer hinder solution is carefully dripped in small droplets to spread evenly over the monomer powder layer directly onto the surface of the dental model. Secondly this procedure is repeated until the dental model is completely covered with the powder-liquid mixture for about a thickness of 5mm at the labial end of the model deep end. Then, the dental model is immersed with the mixture into a pressure pot with water at 45-55° C. under 10-25 psi for 10-20 minutes (see Table 7). The dental model is finally removed from the pressure pot and a sharp tool is used to remove the cured retainer.

The final finishing of the orthodontic appliance including trimming, polishing and washing may be performed as per general protocols known in the art. The S&P technique may be compatible with dental models prepared using many forms of additive manufacturing such as DLP-SLA, LCD-SLA, and Laser SLA.

Example pressure pot processing parameters are provided in Table 7 below,

TABLE 7
Pressure pot processing parameters for various
acrylics tested with dental models prepared
according to the invention.

| Acrylic | Water | | | | Holding |
|---|---|---|---|---|---|
| Brand | Temperature | | Pressure | | time |
| Name | ° C. | ° F. | psi | bar | (min) |
| JBC | 40 | 104 | 15 | 1 | 5 |
| GLO | 40 | 104 | 15 | 1 | 6 |
| Lang | 40 | 104 | 15 | 1 | 6 |
| Dentaurum | 45 | 113 | 15 | 1 | 15 |

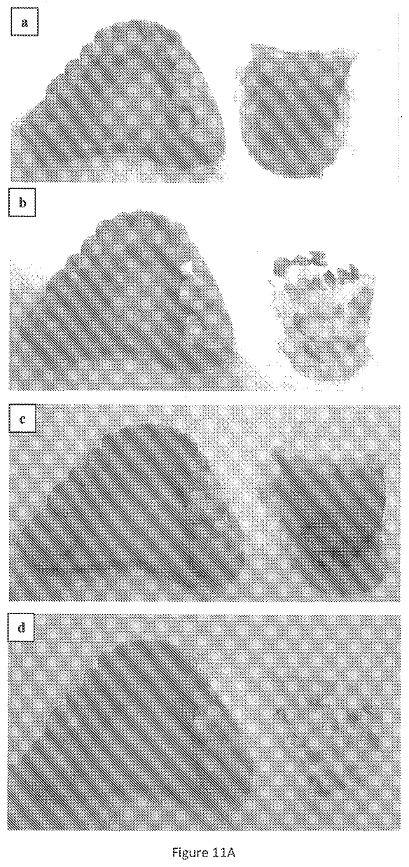

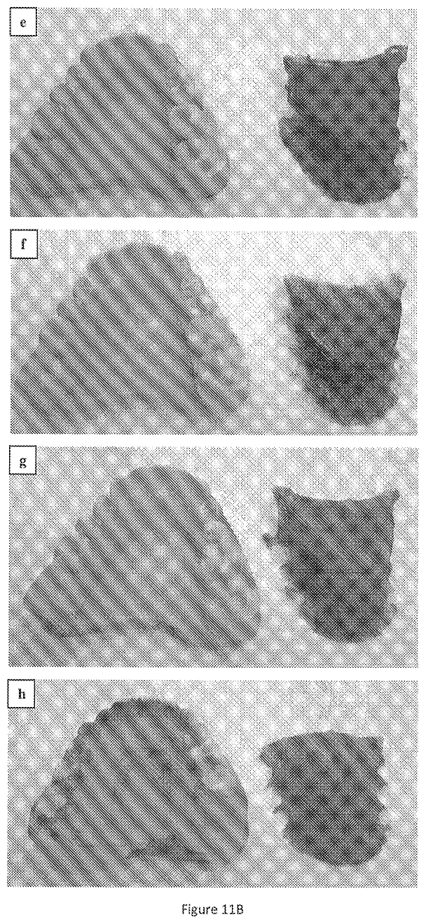

The dental model of the invention was found to be compatible with various different acrylic products, tested and shown in Table 8 and FIG. 11, demonstrating the effectiveness of the dental models in making acrylic retainers without the use of separators.

TABLE 8
List of various acrylic brands tested and
compatible with dental models prepared according
to the invention.

| Brand | Product Name |
|---|---|
| JBC | Crystal Clear Monomer Z and Clear Polymer |
| | Powder |
| | Tinted (Clear 906/Black Onyx 13/Grass Green |
| | I./Fluorescent Pink E) Monomer and Candy |
| | Apple Red 25 Polymer (Opaque) |
| | Crystal Clear Monomer Z and Red Sparkle aa |
| | (Glitter)/Luminary Pink 2 (Glow) Polymer |
| | Unscented (Crystal Clear Z/Tinted Clear 906/ |
| | Standard Pink 905/Cherry Tint C) Monomer and |
| | Candy Apple Red 25 Polymer (Opaque) |
| Lang | Ortho Jet Powder (REF 1330) and Ortho Jet |
| | Liquid-Pink tint (REF 1304) |
| GLO | Superfine Clear Polymer Powder (040-017) and |
| | Clear Monomer Liquid (040-022) |
| Dentaurum | Orthocryl PMMA Clear Powder and Orthocryl |
| | Monomer Liquid (Pink) |

Another example of a method of forming an orthodontic appliance is the ‘Night Guard Investing technique’, which is described below.

Firstly, the Flask upper and flask lower are prepared by additive manufacturing (e.g. 3D printing) and assembled together in such a way that the occlusal spate between them is sufficiently suited to match the shape of the final orthodontic appliance. A spacer ring may be added to control the thickness and alignment of the entire set-up. Once the flask upper, spacer ring and flask lower are set in place, the monomer-polymer powder paste or acrylic liquid or any desired polymeric material suitable for the manufacture of similar orthodontic appliances is injected or applied to the occlusion space. The entire setup is then clamped and conditioned in a pressure pot at an appropriate temperature and pressure for the paste to set. Once the curing is complete, the assembly may be dismantled for the final trimming and finishing of the orthodontic appliance. This method reduces the number of steps involved in making orthodontic appliances which can be seen a viable and efficient alternative to the mufti-step investing technique (see FIG. 12).

For some orthodontic appliances (e.g. a set of dentures), the Flasking technique can be used. First, the two part dental impression models may be prepared by additive manufacturing (e.g. 3D printing). The parts can then be assembled in two separate metal flasks. Each flask carrying the model impression has slots/gaps for insertion of the ceramic/porcelain teeth. Once the teeth have been inserted into the respective slots in the model, the flask upper for the corresponding model and the spacer may be added ensuring the spacer controls the thickness of the resultant denture. A suitable denture acrylic paste is injected in the gap between the models. The entire assembly would then be placed in a flask, clasped and immersed in a water bath for polymerisation similar to that followed in a traditional flasking process. Once complete, the flask parts may be dislodged to obtain the processed denture for further trimming and finishing. This method also significantly reduces the number of intermediate steps in the flasking process making it an efficient alternative method. A similar concept of flasking may be applicable to other orthodontic devices as well.

The dental model prepared from the curable composition can be used in combination with various processing techniques and parameters to fabricate various orthodontic and dental appliances. The Table below shows non-limiting examples of suitable curing conditions for different orthodontic appliances and curing techniques.

TABLE 9
Examples of process parameter ranges to
be suitable for use with S&P resin for various
methods of orthodontic appliance fabrication.

| | | Curing | Curing Pot | |
|---|---|---|---|---|
| | Curing Pot | Pot | Holding | |
| | Temperature | Pressure | time | |
| Appliance | (° C.) | (Psi) | (minutes) | Technique |
| Hawley | 5-100 | 10-90 | 1-30 | Salt & |
| Retainer | | | | Pepper |
| Night Guard | 5-100 | 10-90 | 1-60 | Investing |
| Denture | Cycle 1: 5-100 | 50-3000 | 30-600 | Flasking |
| | Cycle 2: 50-100 | (Flask | 30-300 | |
| | Cycle 3: 80-100 | press | 30-120 | |
| | | pressure) | | |

Different Process Parameters Associated to Methods for Making 3D Printed Dental Models

Certain process parameters relevant to the methods of making dental models are discussed below.

Heat

The curable composition may be mixed at an elevated temperature (30-80° C.) to facilitate uniform mixing and melting of particulates such as waxes and other solids before or during homogenisation. This allows the curable composition to have consistent properties such as viscosity and colour that would translate to the target surface properties required for the application. The working temperature of the curable composition may be set to above room temperature (above 23° C.) for efficient dissolution and mixing of particulates and fillers which otherwise may have solidified or settled under room temperature, leading to undesired properties. The additively manufactured dental model may be subjected to thermal post processing at 50-120° C. to enhance the mechanical and thermal performance characteristics of the material. The thermal post processing may also contribute to a higher percentage of crosslinking efficiency leading to superior material properties.

Blue Light or UV

The curable composition may comprise a photopolymer which may be responsive to a broad wavelength of UV or blue light from 320-450 nm. The spectrum allows the composition to be tuned to be responsive to different light wavelengths during additive manufacturing and post-processing. Moreover, the time of exposure (around 10-60 mins) and the combination of light wavelength may be used to control the polymer density which translates to the material properties desired for the application. It may also be possible to use separate post processing units (UV-A, UV-B, 420 nm) with different wavelength of light in combination with heat to optimize for the most desired material outcome.

Two-Part Chemistry

The curable composition may be multiphasic in nature and may require being mixed before use. The presence of all necessary ingredients in a single combination may reduce the shelf life of the formulation. Thus, two-part chemistry may be implemented to facilitate mixing of the necessary components upon use and prolong the shelf life of the composition. Exemplary two-part compositions are described below for illustrative purposes.

TABLE 10
Illustrative examples of two-part composition matrix for the formulation kit.

| Composition in | | | | |
|---|---|---|---|---|
| wt/wt % (Part 1) | Example 6 | Example 7 | Example 8 | Example 9 |
| Monomer/oligomer | Bisphenol A- | Monofunctional | Trifunctional | Trifunctional |
| | glycidyl | methacrylate | acrylate (18) | acrylate (10) |
| | methacrylate (20) | (15) | Bisphenol A epoxy | Multifunctional |
| | Difunctional | Bisphenol A | dimethacrylate | acrylate |
| | acrylate (10) | epoxy | (22) | (20) |
| | Bisphenol A epoxy | dimethacrylate | Bisphenol A epoxy | Monofunctional |
| | methacrylate (14) | (20) | methacrylate (16) | methacrylate |
| | | Propoxylated | | (13) |
| | | neopentyl | | Propoxylated |
| | | glycol | | neopentyl |
| | | diacrylate (4) | | glycol |
| | | | | diacrylate (8) |
| Reactive diluent | Isobornyl acrylate | Triethylene | Isobornyl acrylate | Isobornyl |
| | (10) | glycol | (10) | methacrylate |
| | Isobornyl | dimethacrylate | Isobornyl | (16) |
| | methacrylate (13) | (8) | methacrylate (13) | Triethylene |
| | | | | glycol |
| | | Isobornyl | | dimethacrylate |
| | | acrylate (5) | | (10) |
| | | Isobornyl | | |
| | | methacrylate | | |
| | | (10) | | |
| Stabilizer | Aliphatic Urethane | Aromatic | Aliphatic | Modified |
| | Tetraacrylate (5) | Urethane | Urethane | Bisphenol-A |
| | | Hexaacrylate | methacrylate (3) | Epoxy |
| | | (5) | Aliphatic | Diacrylate (2) |
| | Difunctional | Hexa- | Urethane | Aliphatic |
| | bisphenol A epoxy | functional | Triacrylate (1) | Urethane |
| | methacrylate (3) | aliphatic | | Hexaacrylate |
| | | urethane | | (2) |
| | | acrylate (5) | | |
| Binders | Silicone polyester | Aliphatic | Aliphatic | Aliphatic |
| | acrylate | siliconized | siliconized | siliconized |
| | (8) | urethane | urethane | acrylate urethane |
| | | acrylate | (4.5) | acrylate |
| | | (2) | | (4.5) |
| | | Silicone | | |
| | | polyester | | |
| | | acrylate | | |
| | | (4) | | |
| Fluoro Acrylate | 1H, 1H, 3H- | 1H, 1H, 3H- | 1H, 1H, 3H- | 1H, 1H, 3H- |
| | hexafluorobutyl | hexafluoro- | hexafluorobutyl | hexafluoro- |
| | acrylate (5) | butyl acrylate | acrylate | butyl acrylate |
| | Trifluoro ethyl | (5) | (4.0) | (3.5) |
| | methacrylate (3) | Perfluoro | | |
| | | polyether | | |
| | | acrylate (2.5) | | |
| Colorant | UV-responsive | Brilliant blue | Green azo dye | UV-responsive |
| | pigment-white | FCF dye (0.08) | (0.05) | pigment-white |
| | (0.35) | UV responsive | UV-responsive | (0.5) |
| | UV responsive | pigment-blue | pigment-white | |
| | pigment-blue | (0.12) | (0.45) | |
| | (0.15) | UV- | | |
| | | responsive | | |
| | | pigment- | | |
| | | white (0.3) | | |
| Additives | Ethoxylated alkyl | Ethoxylated | 4,6- | Ethoxylated |
| | amine | alkyl amine | bis(octylthio- | alkyl amine |
| | (5) | (5) | methyl)-o-cresol (2) | (3.5) |
| | | Fatty acid | Ethoxylated alkyl | |
| | | ester | amine | |
| | | (5) | (2) | |
| | | | Fatty acid ester | |
| | | | (1) | |
| Surfactant | Polyether- | Polyether- | Polyether- | Polyether- |
| | modified, acryl- | modified | modified PDMS | modified |
| | functional | PDMS based | based surface | PDMS based |
| | polydimethyl- | surface | modifier (0.5) | surface |
| | siloxane (0.5) | modifier (0.5) | | modifier (0.5) |
| | Fluorosurfactant | | | Fluorosurfactant |
| | (0.5) | | | (0.5) |
| Photoinitiator | Diphenyl (2,4,6- | Diphenyl | Diphenyl (2,4,6- | 1-Hydroxy- |
| | trimethyl | (2,4,6- | trimethyl | cyclohexyl- |
| | benzoyl)phenyl | trimethyl | benzoyl)phenyl | phenyl-ketone |
| | phosphine oxide | benzoyl)- | phosphine oxide | (0.5) 5,7- |
| | (1.5) | phenyl phosphine | (0.5) | diiodo-3- |
| | Phenylbis (2,4,6- | oxide (1.0) | | butoxy-6- |
| | trimethyl | 1-Hydroxy- | | fluorone (2) |
| | benzoyl)phenyl | cyclohexyl- | | |
| | phosphine oxide | phenyl- | | |
| | (1.0) | ketone (0.25) | | |
| | | 5,7-diiodo-3- | | |
| | | butoxy-6- | | |
| | | fluorone | | |
| | | (0.25) | | |
| Fillers | — | Melamine | Melamine | Melamine |
| | | cyanurate | phosphate (1) | polyphosphate |
| | | (0.5) | Tetraethyl | (3.5) |
| | | Polyhedral | Orthosilicate (1) | |
| | | Oligomeric | | |
| | | Silsesquio- | | |
| | | xane (0.5) | | |

Surface Treatment

Surface modification/treatment methods such as wet sanding, mineral oil finishing, spray coating and/or salinization may be performed where necessary to aid in the desired surface property of the dental model after additive manufacturing. The liquid form of the material may be used to spray coat surfaces as necessary to modify the surface nature and provide non-adhesive properties, Surface treatment can be used to achieve properties such as smooth surface finish, even surface morphology, surface lubrication, friction reduction, improving glossiness and transparency such as in case of dear materials, UV protection against yellowing of the clear material or the like.

Different types of Orthodontic appliances which can be fabricated using the Dental Model

As used herein, the term “orthodontic appliance” refers to an appliance or object which is useful in orthodontics. Examples of orthodontic appliances as used herein include standard Hawley retainers (standard facing bow and acrylic facing bow), wrap-around Hawley retainers (standard facing bow and acrylic facing bow), soldered Hawley retainers (standard facing bow and acrylic facing bow), flat bow, fitted bow, clear bow, anterior bite plate, posterior bite plate, NAM plate, fixed lingual retainer-V shaped (canine to canine), fixed lingual retainer-straight (canine to canine), reset(one tooth), reset(more than one tooth), activator, bionator (standard, class III, open bite), rapid palatal expander-hyrax, rapid palatal expander- mini hyrax, quad helix, lower lingual arch, transpalatal arch, twin block, spring aligner, nance appliance, rapid palatal expander-superscrew, positioner, holding arches, space maintainer, articulator, wax bite and basing, temporary anchorage device, 3-way appliance, Frankel Appliance (Buccal Shield, Lip pads, Lingual Shield including I, II, III, IV &V types), labial bow, acrylic facing wax-up, tongue grip, w-arch, lower fixed Schwartz, one side standard, one side wraparound, lower incisal clasping, twin block appliance, Acrylic Cervical Occipital Anchorage, Mono-Bloc Appliance, Rickonator, Dynamax Appliance, Braces mouthguard, B-Appliance, Anterior Inclined Bite Plate (AIBP), Schwarz Double Plate, Activator appliance, Split Activator (Bow activator), Eschler's Modification, Harvold Woodside Activator, Herren's Activator (1953), Occlus-o-Guide, H-Activator, Klammt Activator, LM-Activator, LSU Activator, V-Activator, Schwarz Activator, Medium Opening Activator, Expansion and labial segment alignment appliance (ELSAA),mouth protectors, boil and bite mouth protectors, Kinetor Activator, Bow activator, Herren's activator, Shaye activator, Elastic Open activator, Nite guide, Open-T activator, Wood side activator, Harvold activator, Palate free activator, Sleep apnea device, Propulsor, U-bow activator, Wunderer activator, Hamilton expansion activator, Cybernator, LM activator, hard night guard, thermoplastic night guard, dual laminate night guard, hard splint, soft splint, Occlusal splint, Muscle relaxation appliance, stabilization appliance, Anterior repositioning appliances, orthopedic repositioning appliance, Anterior bite plane, Pivoting appliance, soft resilient appliance, Permissive splints, muscle deprogrammer, Directive splints, non-permissive splints, Pseudo permissive splints, Hydrostatic splint, neuro muscular appliance, indirect bonding tray_{;}

full dentures, partial dentures, implant supported dentures, flexible partial dentures, Dorsal Splint Superior Repositioning Splint, Farrar Splint, Maxillary Anterior, Deprogrammer, Maxillary Flat Plane, Stack Bionator, Luco Splint, Gelb Splint/MORA, Modified Gelb Splint, Tanner Repositioning Splint, Pull Forward Splint, Flat Occlusal Plane Splint, Mini Deprogrammer, “B” Splint (Wilkerson Style), Cranham Deprogrammer, Kois Deprogrammer, Full Contact Splint with Anterior Guidance (Pankey Style, Brucia/FACE Style, Dawson Style, Spear Style),. The examples of such orthodontic appliances fabricated using 3D printed models as described herein, may not be limited to only those mentioned or the methods applicable herein.

Other Surface Property Control-Based Applications

As discussed herein, the make-up of the curable composition can result in the desired surface properties of the eventual dental model. This tuning of surface properties can be applied to a wide range of applications within the dental field. The curable composition could therefore be used to engineer materials for dental/medical devices and implants that require the relevant surface properties. ⁴ The functionality does not need to be based on tuning non-adhesion and wettability features but can also be used to include more active physical, chemical and biological responses targeting detection, sensing and therapeutic effects where necessary.

Effective control over surface properties can exhibit great potential in the case of implant performances, such as the acceleration of osseointegration even in poor quality bone, protection from chemical corrosion exerted by body fluids, and the reduction of bacterial adhesion. Control over surface properties can also be applied to various applications in the biomedical industry such as in wound care products, orthopaedic devices, biomedical sensors, catheters, blood bags, renal dialyzers, vascular grafts, oxygenators etc, The modification of surface property by controlling the nature of ingredients within a formulation allows applications in enabling properties such as chemical stability, weathering resistance, super-hydrophobicity, oleophobicity, anti-corrosion, anti-microbe, and anti-fouling characteristics which are extremely valuable in the medical, food packaging, and marine industries. ⁵

All of the features or chemical entities described herein (including any accompanying claims, abstract and drawings), and/or all or any part of the steps of any method or process so disclosed, may be combined with any of the above aspects in any combination. It is to he understood that the foregoing describes preferred embodiments of the invention and that it will be apparent to those skilled in the relevant art that various modifications, additions, substitutions, and the like may be made therein without departing from the spirit or scope of the invention as set forth in the claims.

### REFERENCES

1. Retainer and method of making, Quach et at, US Patent Application; US005083919A.
2. The effect of gypsum products and separating materials on the typography of denture base materials, Firtell, David N. et at, Journal of Prosthetic Dentistry, Volume 44, Issue 3,254-258.
3. Effect of Separating Medium on Typography of Denture Base Resin, Kim et at, J Prosthet Dent., 2014; 112:1001-1005.
4. Modifying and managing the surface properties of polymers, Hutchings et al., Polymer International, 57:163-170 (2008).
5. Surface modification of polymers for medical applications, Y. Ikada, Biomaterials, 1994. Vol. 15 No. 10: 725-736.

1. A method of forming an orthodontic appliance comprising:
forming a dental model of a subject's mouth by an additive manufacturing process; and
forming an orthodontic appliance directly on the dental model without the use of a separating liquid, film or layer.

2. A method according to claim 1 wherein the orthodontic appliance is formed on the dental model using a salt & pepper, investing or flasking method.

3. A method according to claim 1 wherein:
(a) the additive manufacturing process uses a curable composition comprising:
a monomer and/or an oligomer suitable to form a polymer;
a reactive diluent;
a polymerisation initiator;
a silicone acrylate; and
a fluorinated acrylate, or
(b) the additive manufacturing process uses a curable mixture comprising a first composition and a second composition,
the first composition comprising:
a monomer and/or an oligomer suitable to form a polymer;
a reactive diluent;
a silicone acrylate; and
a fluorinated acrylate; and
the second composition comprises:
a polymerisation initiator.

4. A method according to claim 3 wherein the fluorinated acrylate is a perfluorinated acrylate.

5. A method according to claim 3 wherein one or both of the following apply:
a) the monomer and/or oligomer is an acrylate, methacrylate, epoxy, urethane or silicone monomer and/or oligomer, or is a styrene, vinyl alcohol, olefin or glycerol oligomer; and
b) the reactive diluent is isobornyl acrylate, isobornyl methacrylate, trimethylolpropane triacrylate, triethylene glycol dimethacrylate, 4,4′-oxydianiline, iminodiacetic acid, octadecanedioic acid, dipropylene glycol diacrylate, tripropyleneglycol diacrylate, or the reactive diluent is a multi-functionalized methacrylate, a monoalkenyl aromatic hydrocarbon, an ester of acrylic or methacrylic acid with a C₁₋₁₈ alcohol, an ester of a dicarboxylic acid with a C₁₋₁₈ alcohol, a hydroxyl acrylate or methacrylate, an alkyl hydroxyalkyl ester of maleic acid, an alkyl 2-hydroxyalkyl ester of itaconic acid, an alcohol having an allyl group, an amide or a hydroxy alkylstyrene.

6. A method according to claim 1 wherein the dental model has non-adhesive properties and the orthodontic appliance does not adhere to the dental model.

7. A method according to claim 1 wherein the dental model is formed from a composition comprising one or both of:
a fluorinated compound; and
a silicone compound.

8. A curable composition for use in forming a dental model, the composition comprising:
a monomer and/or an oligomer suitable to form a polymer;
a reactive diluent;
a polymerisation initiator;
a silicone acrylate; and
a fluorinated acrylate.

9. The composition according to claim 8, wherein:
the monomer and/or an oligomer is present in an amount of from 20 to 70 wt %;
the reactive diluent is present in an amount of from 10 to 30 wt %;
the initiator is present in an amount of from 1 to 5 wt %;
the silicone acrylate is present in an amount of from 2 to 30 wt %; and
the fluorinated acrylate is present in an amount of from 2 to 10 wt %.

10. (canceled)

11. The composition according to claim 8, wherein the composition further comprises a surfactant, optionally wherein the surfactant is present in an amount of from 0.1 to 10 wt %.

12. The composition according to claim 8, wherein the composition further comprises one or more of:
(a) an additive;
(b) a filler; and
(c) a colourant.

13.-16. (canceled)

17. A kit of parts comprising a first and second composition,
the first composition comprising:
a monomer and/or an oligomer suitable to form a polymer;
a reactive diluent;
a silicone acrylate; and
a fluorinated acrylate; and
the second composition comprises a polymerisation initiator.

18.-25. (canceled)

26. A non-adhesive polymer product obtainable by curing a curable composition according to claim 8.

27. (canceled)

28. A dental model for making an orthodontic appliance wherein
the dental model comprises a polymer product according to claim 26.

29. A method of forming an orthodontic appliance comprising the use of a curable composition according to claim 8.

30. A dental model for making an orthodontic appliance comprising a composition according to of claim 8.

31. A method according to claim 29 wherein one or both of the following apply:
(a) the model used to fabricate the appliance has a polymeric component, where the surface of the polymeric component has non-reactive, non-adhesive and solder resistant properties; and
(b) the orthodontic appliance is a Hawley retainer.

32. A method according to claim 1 wherein one or more of the following apply:
(a) the dental model has non-reactive properties and does not react with the orthodontic appliance or materials used to form the orthodontic appliance;
(b) the dental model has solder resistant properties,
(c) the dental model has hydrophilic surface properties, and
(d) the dental model has hydrophobic surface properties.

33. A non-adhesive polymer product obtainable by curing a curable mixture comprising a first composition and a second composition as defined in claim 17.

34. A dental model according to claim 30 wherein one or both of the following apply:
(a) the model used to fabricate the appliance has a polymeric component, where the surface of the polymeric component has non-reactive, non-adhesive and solder resistant properties; and
(b) the orthodontic appliance is a Hawley retainer.
